(19) United States
(12) Patent Application Publication
(10) Pub. No.: US 2002/0183059 A1
(43) Pub. Date: Dec. 5, 2002

(54) Interactive system and method for use with broadcast media

(76) Inventors: Gary Keith Noreen, La Canada Flintridge, CA (US); Stephen P Crosby, Brookline, MA (US); Carl A. Kukkonen III, Pasadena, CA (US); Daniel C. Kukkonen, Hollywood, CA (US)

Correspondence Address: CARL A. KUKKONEN, III, C/O VIASPACE TECHNOLOGIES LLC, 2400 LINCOLN AVENUE, ALTADENA, CA, 91001, US

(21) Appl. No.: 10/149,341

(22) PCT Filed: Dec. 7, 2000
(86) PCT No.: PCT/US00/33447

(51) Int. Cl. H04L 12/28; H04Q 7/20; H04M 1/00; H04B 1/38

(52) U.S. Cl. 455/427; 455/553; 455/557; 370/351

(57) ABSTRACT

An interactive media system (100) is provided for use with broadcast media wherein feedback is provided to subscribers of the system via subscriber access devices. Interactive radio mobile units are mounted within vehicles (104) or at other locations. In some embodiments, each mobile unit includes a receiver (116) for receiving radio broadcasts, a GPS system (118) for determining the location of the vehicle (104), and a wireless transmitter (120) for transmitting interactive radio control signals to a network operation center (110). While listening or viewing a media broadcast, the subscriber selects program segments of interest by pressing an interactive radio control button on the mobile unit. The program segments are, for example, individual musical selections, advertisements or the like. In response, the mobile unit transmits the carrier frequency of the radio broadcast, the date and time, the geographical location of the vehicle, and a subscriber identification signal to the network operation center (110) using the wireless transmitter (120). The network operations center (110) determines the identity of the selected program segment based upon the information transmitted from the mobile unit. Then, the network operation center (110) accesses databases (202) providing information pertaining to the selected program segment and provides the information to the subscriber via the Internet (111), such that the information can later be retrieved by the subscriber using a home or office computer (112) or the like.

### BACKGROUND OF THE INVENTION

1. Field of the Invention

The invention generally relates to interactive systems and in particular to interactive systems for use with broadcast media.

2. Description of Related Art

U.S. Pat. Nos. 5,303,393, 5,455,823 and 5,689,245 to Noreen et al. describe various interactive radio systems for use with broadcast radio. In one example, individual mobile interactive radio units are installed in motor vehicles or other locations for use by subscribers of the interactive radio system. Each mobile unit includes a radio broadcast receiver, such as a standard automobile radio, and a two-way wireless communication device, such as a wireless telephone. Radio broadcasts received by the mobile unit are listened to by the subscriber, perhaps while driving the vehicle. The subscriber may respond to advertisements, solicitations, promotional segments or the like by entering commands through the mobile unit, which are transmitted by the mobile unit to a network operations center. As one specific example, if the subscriber wishes to purchase a product advertised during a radio broadcast, the subscriber enters an order or purchase command into the mobile unit and the command is forwarded to the network operations center, which coordinates the purchase of the product on behalf of the subscriber. To this end, the broadcast signal may be encoded with sub-signals which identify the product offered for sale during the segment of the broadcast. The mobile unit extracts the product identification from the broadcast signal and generates a purchase command, which identifies the product being purchased along with the identity of the subscriber associated with the mobile unit. The network operations center maintains a credit card number or other purchase authorization information for the subscriber for completing the purchase. If the broadcast signal is a standard radio broadcast signal not encoded with sub-signals, the mobile unit determines the carrier frequency of the broadcast, the date and time of the broadcast, and the geographical location of the mobile unit and then transmits this information along with the purchase command and identity of the subscriber associated with the mobile unit to the network operations center. In response, the network operations center determines the identity of the broadcaster based upon the carrier frequency and the geographical location of the mobile unit, then accesses databases identifying particular program segments broadcast by the broadcaster at various dates and times. With this information, the network operations center determines the goods or services that the subscriber wishes to purchase and completes the purchase on behalf of the subscriber.

Although summarized with respect to an example involving the purchase of goods or services advertised during radio broadcasts, the interactive radio systems of the Noreen et al. patents provide a wide range of other interactive services as well. In other examples, the subscriber may respond to opinion polls solicited through radio broadcasts, or donate money to charities or political causes solicited through the radio broadcast. Additionally, the mobile interactive radio unit may be provided with a graphic display for providing information identifying particular songs broadcast over the radio or particular products advertised in radio broadcasts. In the example wherein the broadcasts are encoded with sub-signals identifying the particular product being offered for sale, the encoded information may be displayed on the graphic display for viewing by the subscriber while listening to the broadcast.

Thus, interactive radio is enabled using radio broadcasters, such as satellite radio broadcasters or conventional AM/FM or digital land-based radio broadcasters. Hence, the audio content need not be transmitted via cables, telephone lines, or other wire-based systems. Moreover, because broadcast radio is employed, operators of the interactive radio system can reach potentially millions of subscribers, including subscribers at remote locations who may not have access to wired interactive systems such as cable-based systems. Moreover, those who possess only a conventional radio can receive radio broadcasts as normal. Those who possess one of the mobile interactive radio units and are subscribers to the interactive radio system receive the additional benefits provided by the interactive radio system. Hence, the radio broadcasters can reach both subscribers and non-subscribers to the mobile interactive radio system. Another advantage of the system is that the only signals that need to be transmitted from the mobile units to the network operations center are relatively infrequent subscriber command signals generated, for example, when the subscriber selects a product to purchase. Hence, very little bandwidth is required by the wireless communication system to communicate transmissions from the mobile unit to the network operations center.

Although the systems of the Noreen et al. patents have many advantages over non-broadcast-based interactive radio systems, such as cable-based radio systems, room for further improvement remains. For example, it would be desirable to provide an alternative method for providing text or graphic information to the subscriber that does not always require that the text or graphic information be transmitted to the mobile unit and displayed on the mobile unit. In some cases, by providing a method that does not require that the information be displayed on the mobile unit, the mobile unit thereby need not include a graphic display. By eliminating the need to provide a graphic display in the mobile unit, the mobile unit may be less expensive and perhaps less distracting to the subscriber, which is particularly advantageous if the mobile unit is mounted within a motor vehicle for use by the driver of the vehicle. Also, it would be desirable to provide an interactive radio system that is capable of providing vast amounts of text or graphic information to the subscriber pertaining to selected program segment without always requiring that the information be transmitted to the mobile unit via the two-way wireless communication device. Also, it would be desirable to provide an interactive radio system wherein the subscriber need not make immediate decisions while listening to the radio about whether to purchase goods or services, contribute to charities or the like. Rather, it would be desirable to permit the subscriber to select advertisements, songs, or other program segments of interest and then review information pertaining to those program segments at a later time.

In addition to the objectives described above, it would be desirable to provide for an interactive system with two-way communication capabilities that is applicable to all types of broadcast media such as AM/FM radio, digital radio, satellite radio, televisions broadcasts, and other wireless data transmissions. Furthermore, it would be desirable for such a universal system to be easy-to-use and adaptable.

It is to these and other ends that aspects of the present invention are primarily directed.

### SUMMARY OF THE INVENTION

In accordance with the invention, an interactive broadcast system is provided for use with a mobile unit having a broadcast receiver for receiving broadcast transmissions from broadcasters or other broadcast program originators and a wireless transmitter for transmitting wireless signals to the system. The system includes a means for receiving a broadcast attribute signal transmitted from the mobile unit. The broadcast attribute signal identifies at least one attribute of a broadcast transmission selected by a user of the mobile unit. The system also includes means, responsive to receipt of the broadcast attribute signal, for providing information to the user associated with the mobile unit via the Internet. The information provided via the Internet is selected based upon the content of the broadcast transmission selected by the user.

In an exemplary embodiment, the broadcasts are radio broadcasts. The broadcast receiver is a radio, such as an AM/FM automobile radio or a mobile satellite radio. The wireless transmitter is a two-way wireless communication device, such as a satellite wireless communication device or a cellular telephone. The user of the mobile unit is a subscriber of the interactive radio system. The term subscriber, as used herein, refers to a subscriber of the interactive radio system, rather than a subscriber to a particular radio broadcast service, such as a satellite digital radio broadcast service. Depending upon the particular implementation, the individual user of a particular mobile unit may be both a subscriber to the interactive radio system and a subscriber to particular radio broadcast systems. The subscriber may be charged a fee for accessing the interactive radio system. Alternatively, the subscriber may be able to access the system without paying a fee. In still other implementations, users of the interactive radio system need not necessarily subscribe to the system. The broadcast attribute signal transmitted by the wireless communication device identifies the date and time of a program segment selected by the subscriber, the carrier frequency of the broadcast, and the geographical location of the radio as determined using a global positioning system (“GPS”) device or, in the case of a mobile unit using a cellular telephone, the geographical location of the cellular base station receiving the wireless transmission. The wireless communication device of the mobile unit also transmits a client identifier signal which identifies either the subscriber using the mobile unit or the mobile unit itself. If the signal identifies the mobile unit, the system accesses client information databases to determine the identity of the subscriber associated with the mobile unit. The system determines the identity of the broadcaster or other program originator based upon the carrier frequency and the geographical location of the mobile unit. Then, the system accesses a database of information provided by the broadcaster that identifies the date and time of various program segments broadcasted by the broadcaster. Alternatively, this information may be provided by a third party monitoring service such as those described below. From this information, the system identifies the particular program segment selected by the subscriber. The program segment may be an advertisement, charity solicitation, musical selection or the like. Once the program segment has been identified, the system provides information pertaining to the program segment to the subscriber via a web site accessible by a home or office computer of the subscriber or via an e-mail sent to an email account associated with the subscriber.

In this manner, the subscriber can select various advertisements, musical selections or the like while listening to the radio, then access the Internet at a later time to review information pertaining to the various program segments that have been selected. For program segments that comprise musical selections, the information provided through the Internet identifies such things as the name of the song, the performer, and the compact disk (CD) or other compilation containing the song. Hyperlinks are provided within the web page or e-mail for linking the subscriber directly to web sites provided by the performer, record company or the like. The CD may be purchased directly through the web site. Alternatively, links are provided for permitting the CD to be purchased through other e-commerce web sites. Also, either the web site of the interactive radio system or other e-commerce sites permit the subscriber to generate and purchase a customized CD containing a group of songs that have been selected by the subscriber or permitting customized digital music files, such as MP3 files, to be generated containing songs that have been selected. For program segments containing advertisements, the information provided via the e-mail or web page identifies the advertiser and provides links directly to e-commerce web sites providing further information regarding the advertiser or its products and permitting immediate purchase of the products. As can be appreciated, a wealth of information may be provided to the subscriber via the Internet pertaining to broadcast radio segments selected by the subscriber.

One advantage of the Internet feedback system of the invention is that the subscriber need not necessarily make decisions immediately regarding purchase of goods or services while listening to the radio broadcast but may defer decisions until a later time. Alternatively, though, the system may be configured such that the subscriber may immediately purchase goods or services via the mobile unit. If so, confirmation of the purchase is provided via the Internet. In still other implementations, the subscriber may enter a purchase order through the mobile unit then, if desired, cancel the order via the Internet at a later time. Another advantage of the Internet feedback system is that the subscriber is directly linked to e-commerce sites permitting ease of purchase of the goods or services. Also, much more information may be provided to the subscriber pertaining to selected program segments than can easily be accommodated via two-way wireless transmissions to the mobile unit. Moreover, by providing text and graphic information through the Internet to a home or office computer of the subscriber, the mobile unit need not necessarily include a graphic display and hence may be less expensive and thereby more desirable for some potential subscribers. Although, in other implementations, a graphic display is provided in some mobile units to permit at least a portion of the Internet content to be browsed directly via the mobile unit.

As noted, in the exemplary implementation, the system identifies specific program content selected by the subscriber by examining the carrier frequency of the broadcast in combination with the geographical location of the mobile unit and programming information provided by the broadcasters. In the alternative, the broadcast itself includes information encoded therein identifying the program segments. If so, the mobile unit, in response to subscriber commands, generates a program attribute signal which specifically identifies the content of the program segment and also provides the identity of the subscriber or the identity of the mobile unit, such that the system need not determine the identity of the broadcaster or the program segment. Insofar as providing program information is concerned, the system may either receive information from various broadcasters for storage in dedicated databases maintained by the system or the system may merely access databases maintained by the broadcasters containing play-lists or other program information. In this regard, many broadcasters provide web pages which provide play-lists specifying the date and time of day of the various songs that have been played. The system may access those web pages to identify specific program segments selected by the subscriber. Also, in the exemplary embodiment, GPS is employed for determining the geographical location of the mobile unit. Other techniques for determining the location of the mobile unit, either precisely or approximately, may be employed. In one example, wherein a cellular communication system is employed, the location of the mobile unit is approximated based upon the location of a cellular base station receiving signals from the mobile unit. Alternatively, a regional interactive radio system may be provided for use within a particular region accessible only by broadcasters within that region. In such an implementation, the identity of the broadcaster may be determined based upon the carrier frequency of the broadcast, rather than based upon both carrier frequency and geographical location.

In yet another embodiment, an interactive media system is disclosed that comprises a broadcaster broadcasting program segments, a mobile unit for receiving the program segments and for transmitting subscriber command signals containing data to identify the program segment, a communications network for receiving the transmitted subscriber command signals, a subscriber access device with a user interface for displaying information, and a network operations center. The network operations center is coupled to the communications network for associating the transmitted subscriber command signal with a specific broadcasted program segment. Furthermore, the network operations sends a content signal with information associated to the broadcasted program segment, such as purchase information, for display on the subscriber access device. In some variations, the content signals sent to the subscriber access devices may be tailored according to the position of the mobile unit and to the particular type of subscriber access device employed by the subscriber.

Another embodiment of an interactive media system comprises a broadcaster broadcasting program segments and a mobile unit. The mobile unit comprises a receiver for receiving the program segments, a transceiver for receiving content data signals and for transmitting subscriber command signals containing data which can be used to identify the program segment, and a display for displaying information received via the transceiver associated with the subscriber command signals. Signals to and from the mobile unit are communicated via a communications network that is coupled to a network operations center. The network operations center associates the transmitted subscriber command signals with a specific broadcasted program segment, and transmits back to the mobile unit signals containing information pertaining to the specific broadcasted program segment.

In another embodiment, the interactive media system comprises a broadcaster broadcasting program segments, a mobile unit for receiving the program segments and for transmitting subscriber command signals containing data which can identify the program segment via a WAP-enabled device with a user interface for displaying information, a communications network for receiving and transmitting WAP signals, and a network operations center. The network operations center is coupled to the communications network for receiving through the communications network transmitted subscriber command signals from the mobile unit and associating the transmitted subscriber command signals with a specific broadcasted program segment, and transmitting back to the WAP-enabled device a content data signal via WAP containing information pertaining to the specific broadcasted program segment to be displayed on the user interface of the WAP-enabled device. In such an arrangement, information pertaining to the transmitted subscriber command signals may be immediately accessed by the subscriber via the WAP-enabled device.

In still another embodiment, an interactive media system is disclosed comprising a broadcasting station broadcasting program segments with embedded program information, a mobile unit receiving broadcast transmissions from the broadcasting station and a transmitter for transmitting subscriber command signals containing data identifying the embedded program information. A communications network is employed for receiving the transmitted subscriber command signals from said mobile unit. Also utilized are a network operations center coupled to the communications network for extracting the embedded program information and associating the embedded program information with a program segment, and a subscriber access device coupled to the network operations center for displaying information pertaining to the program segment. The subscriber access device may be a mobile phone, a computer, or other wired or wireless networked computing device.

In yet another embodiment, the current invention provides a system for providing a communications gateway such as a phone link between a subscriber and an advertiser or vendor representative. The system includes a broadcaster broadcasting program segments, a mobile unit for receiving broadcasted program segments from the broadcasting stations and transmitting subscriber command signals containing data to identify the broadcasted program segments. A receiving unit receives the broadcasted subscriber command signals and is coupled to a processing unit for identifying the broadcaster and the program segment and then associating the subscriber command signals with at least one advertiser telephone number. Once this advertiser telephone number or other identifier is available, a communication device coupled to the processing unit initiates a telephone call between the subscriber and the advertiser. Additionally, information relating to the position of the mobile unit may be sent to the advertiser to allow the advertisers to provide information tailored to the position of the subscriber such as local telephone numbers and locations of nearby items of interest.

A further embodiment discloses a method for tracking the usage of an interactive media system. This method utilizes an interactive media system, similar to those described above, which includes a broadcaster broadcasting program segments, mobile units for receiving the program segments and for transmitting subscriber command signals containing data to identify the program segment, a communications network for receiving the transmitted subscriber command signals, and a network operations center coupled to the communications network for associating the transmitted subscriber command signals with program segments broadcasted by the broadcaster. The method, which can be used to provide detailed analyses of the listening patterns of a plurality of users, comprises the steps of providing each of the plurality of subscribers a mobile unit for receiving the program segments and for transmitting subscriber command signals containing data to identify the broadcaster, and transmitting from the mobile unit upon a predetermined condition, a subscriber command signal containing data to identify the broadcaster broadcasting the program segments received by the mobile unit. Additional steps include receiving the transmitted subscriber command signal at the network operations center via the communications network, associating the transmitted subscriber command signal with one or more program segments broadcasted by the identified broadcaster, and providing data pertaining to the program segments received by the mobile units of a plurality of subscribers. This method may also incorporate a transmitted subscriber command signal received at the network operations center via the communications network that contains information pertaining to the location of the mobile unit when receiving a program segment and may further comprise the step of providing data pertaining to the locations of mobile units when receiving program segments for a plurality of subscribers.

In a further embodiment, an interactive media system such as those described above includes a broadcast monitoring device coupled to the network operations center that includes a monitoring device with a receiver for receiving broadcasted program segments and associating said program segments with a specific program segment based on audio matching or other appropriate techniques to associate received program segments with known program segments.

Furthermore, the current invention provides for other applications such as roadside hazard services, theft prevention services, and polling services.

As can be appreciated, a wide range of embodiments are consistent with the general principles of the invention.

### BRIEF DESCRIPTION OF THE DRAWINGS

FIG. 1 illustrates a first exemplary interactive radio system employing land-based broadcast radio stations, a satellite wireless communications system, and the Global Positioning System (GPS), and providing interactive feedback to subscribers via the Internet.

FIG. 2 is a block diagram illustrating pertinent components of a mobile interactive radio unit for use with the system of FIG. 1.

FIG. 3 is a block diagram illustrating pertinent components of a network operations center of the system of FIG. 1.

FIG. 4 illustrates a broadcaster identification database employed by the network operations center of FIG. 3.

FIG. 5 illustrates a broadcast program segment identification database employed by the network operations center of FIG. 3.

FIG. 6 illustrates a vendor information database employed by the network operations center of FIG. 3.

FIG. 7 illustrates an exemplary display screen presented by a web site generated by the network operations center of FIG. 3.

FIG. 8 illustrates a second exemplary interactive radio system employing land-based broadcast radio stations and a cellular communications system, and also providing interactive feedback to subscribers via the Internet.

FIG. 9 illustrates a third exemplary interactive radio system employing land-based broadcast radio stations and a dedicated localized communications system, and also providing interactive feedback to subscribers via the Internet.

FIG. 10 illustrates a fourth exemplary interactive radio system employing satellite-based broadcasters, a satellite wireless communications system, and a GPS system, and also providing interactive feedback to subscribers via a computer feedback network.

FIG. 11 illustrates an additional exemplary interactive radio system providing interactive feedback to subscribers via a subscriber access device.

FIG. 12 illustrates yet another interactive radio system in which broadcast signals contained embedded program information to be associated with a specific program segment.

FIG. 13 illustrates an interactive radio system which opens a communication gateway between the subscriber and a vendor after the depression of a customer response button.

FIG. 14 illustrates an interactive radio system employing a WAP-enabled device to transmit data which can be used to identify a broadcasted program segment, receive information pertaining to the broadcasted program segment, and to display information pertaining to the broadcasted program segment.

FIG. 15 illustrates an enhanced radio system in which program lists associated with a various broadcasters are made available on an interactive mobile radio unit.

FIG. 16 illustrates an interactive radio system utilizing a broadcast monitor for monitoring program segments broadcasted by a broadcaster and associating them with known program segments.

FIG. 17 illustrates a sample flow diagram for identifying a vendor based on the location of an interactive radio mobile unit for use with the systems illustrated in the previous figures.

FIG. 18 illustrates a sample zone database that provides for associating predefined zones with geographic boundaries for use and access by the systems illustrated in the previous figures.

FIG. 19 illustrates a program-segment zone database in which the zones of FIG. 18 are associated with specific vendors for use and access by the systems illustrated in the previous figures.

FIG. 20 illustrates a program-segment area code database in which area codes are associated with specific vendors for use and access by the systems illustrated in the previous figures.

FIG. 21 illustrates a program segment-subscriber access device database in which information appropriate to the particular subscriber access device being utilized for use in the systems illustrated in the previous figures may be accessed.

### DETAILED DESCRIPTION OF THE EXEMPLARY EMBODIMENTS

With reference to the figures, preferred and exemplary embodiments of the invention will now be described. The invention is described primarily with respect to an exemplary interactive radio system for use with standard and enhanced land-based AM/FM radio broadcasters, wireless Internet data transmissions (both audio and video), television broadcasters, a satellite wireless communication system, the Global Positioning System, and the Internet. Several other exemplary systems are also described.

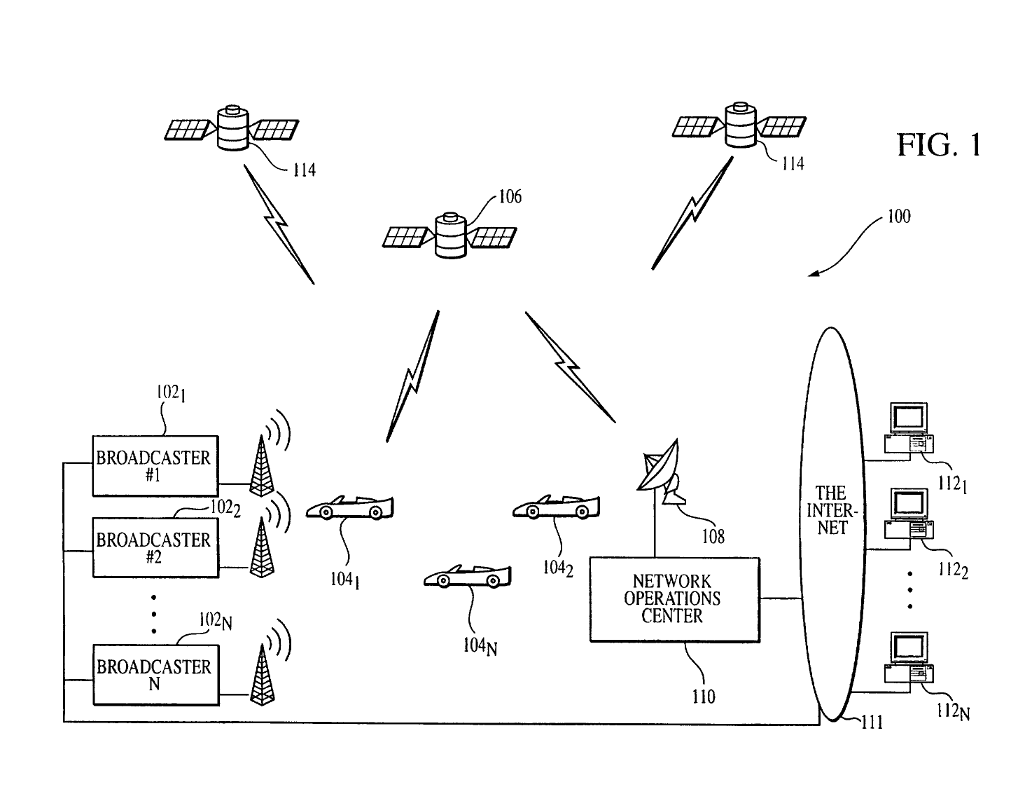

FIG. 1 illustrates an interactive radio network 100 wherein signals broadcast by land-based radio broadcasters 102 are received by interactive radio mobile units or mobile stations mounted within vehicles 104, with each mobile unit operated by a subscriber or other user (not separately shown.) While listening to a radio broadcast, the subscribers transmit commands or other responsive signals (e.g., via the manual depression of a button or via voice commands) from the mobile units via a communications satellite 106 to an interactive radio network ground station 108, which forwards the commands to an interactive radio network operations center 110. In response to commands received from the subscribers, the network operations center provides information feedback to the subscribers via the Internet or other computer network 111, with the information being received at individual subscriber computers, mobile phones, PDA, or other interface device 112. In this manner, subscribers operating mobile units mounted within automobiles, trucks, planes, trains or the like, may request information pertaining to program segments broadcast by the various broadcasters, then review the information later or concurrently via a computer network, such as the Internet, using home computers, work computers, personal digital assistants (PDAs) or the like. As one specific example, a subscriber selects individual songs of interest, then reviews information pertaining to the songs at a later time using his or her home computer. The subscriber thereby obtains information such as the song name and performer name for various musical selections of interest and, if desired, purchases any or all of the songs via e-commerce Internet sites accessible via the computer. As another example, the subscriber responds to opinion polls solicited via broadcast radio segments, with a summary of the poll results provided to the subscriber via the Internet. In yet another example, the subscriber responds to solicitations for charitable donations requested via radio program segments, with further information pertaining to the charities provided to the subscriber via the Internet, such that the subscriber may then make a final decision regarding whether to donate to the charity in question. Many additional applications of the interactive radio system are possible. In one other application, the system is configured to permit a subscriber to immediately enter a purchase order via the mobile unit, then review confirmation information via the Internet. At that time, the subscriber may choose to cancel the order. If, for example, the order is not canceled within twenty-four hours, the order is automatically completed.

Now considering the system of FIG. 1 in greater detail, a set of land-based radio broadcasters 102₁ to 102_{N} each broadcast radio signals which, depending upon the individual broadcaster, are conventional AM or FM analog radio signals, digital radio signals, or radio signals encoded with specific program information, such as the information identifying individual program segments. The various broadcasts are received at mobile units mounted within automobiles, trucks, or the like, denoted 104₁ to 104_{N}. Each mobile unit includes a broadcast radio receiver and a wireless transmitter. The broadcast radio receiver is a conventional AM/FM radio receiver, a digital radio receiver or similar device. The wireless transmitter is a mobile satellite wireless communications device, which transmits signals via satellite 106 to interactive radio ground station 108. (Herein-below, alternative implementations utilizing cellular telephone base stations, two-way paging, or dedicated localized communication systems are described.) The mobile unit also includes a GPS receiver for receiving signals from a set of GPS satellites 114 to determine the geographical location of the mobile unit. (Also herein-below, alternative implementations are described for determining the geographical location of the mobile unit without requiring the use of GPS.)

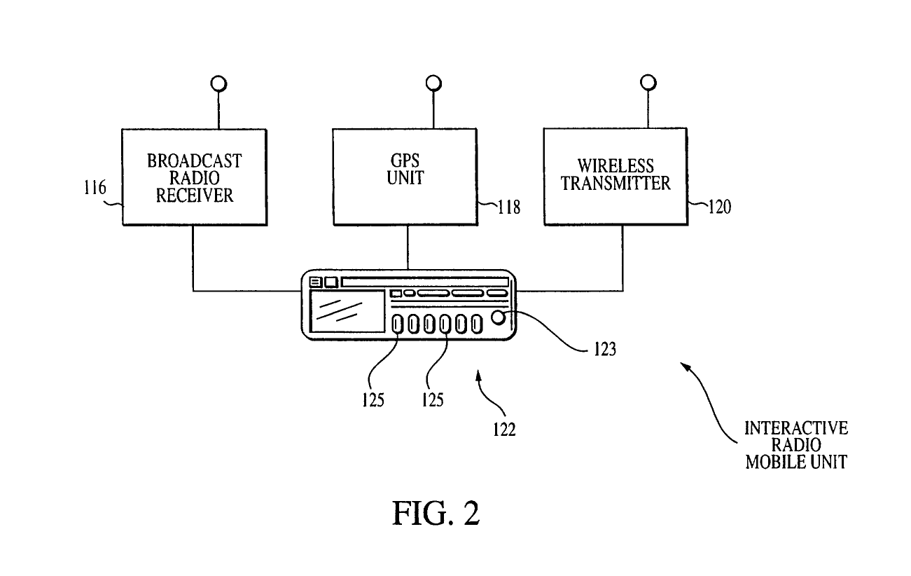

The primary components of the mobile unit are illustrated in FIG. 2 and include a broadcast radio receiver 116, a GPS unit 118. a wireless transmitter 120 and a subscriber interface 122 for receiving control signals from an subscriber via one or more input buttons or other input devices. In the example of FIG. 2, only a single interactive radio control button 123 is provided. In other implementations, to be described in greater detail below, additional buttons are provided. The broadcast radio receiver may include one or more individual radio receiving components such as a terrestrial digital radio receiver, a satellite digital radio receiver, and a terrestrial AM/FM analog radio receiver. The various components of the mobile unit are preferably integrated as a single unit for installation within the vehicle. Alternatively, the various components may be installed separately within the vehicle. In this regard, the interactive radio subscriber interface 122 may be connected to a conventional GPS device, conventional AM/FM radio, and conventional wireless satellite communication device separately mounted within the vehicle. In either implementation, the subscriber interface is preferably mounted to the dashboard of the vehicle or other convenient location for easy access by the driver or passenger of the vehicle. The subscriber interface receives GPS coordinates from the GPS unit and receives radio broadcast signals from the radio receiver then, in response to commands entered by the subscriber, generates various interactive radio signals for transference to the wireless transmitter for transmission to the network operations center of FIG. 1.

Referring again to FIG. 1, network operations center 110 processes the interactive radio signals transmitted by the mobile unit and generates appropriate feedback to the subscriber via the Internet. More specifically, interactive radio signals transmitted by the mobile unit include: a broadcast attribute signal identifying a carrier frequency of the radio broadcast and the date and time the broadcast was received; a location attribute signal identifying the geographical location of the mobile unit at the date and time the broadcast was received; and a subscriber identifier signal providing a subscriber ID or a mobile unit ID. In response to these signals, the network operations center determines the identity of the broadcaster based upon the carrier frequency of the broadcast and the geographical location of the mobile unit. The network operations center then determines the specific program segment selected by the subscriber based upon the identity of the broadcaster and the date and time of the broadcast. Next, the network operations center downloads information pertinent to the program segment and provides that information within a web site accessible by the subscriber, with access granted based upon a subscriber name and password associated with the subscriber ID or mobile unit ID and maintained by the network operations center. The mobile unit ID may, for example, identify the serial number of the mobile unit. If so, the network operation center maintains the subscriber name and password for the subscriber currently registered to use that particular mobile unit. Thereafter, the subscriber may download the information from the web site into his or her computer or PDA by accessing the web site using the subscriber name and password. Alternatively, the network operations center maintains an e-mail address associated with the subscriber ID and transmits e-mail messages containing information corresponding to program segments selected by the subscriber to the subscriber via the designated e-mail address.

In the example wherein the program segment selected by the subscriber is a musical selection, the network operations center provides information including the song title, CD title, performer name, record label and the like within the web site. Additionally, the network operations center provides e-commerce hyperlinks within the web site to link the subscriber to sites permitting the subscriber to purchase the particular musical selection or CD or to download additional information regarding the performer, record label or the like. The network operations center also provides hyperlinks to e-commerce sites permitting the subscriber to create a custom CD or a custom digital music file, such as an MP3 file, containing some or all of the musical selections of interest. In the example wherein the radio program segment selected by the subscriber is a radio advertisement, the network operations center may provide information on a web page identifying the vendor and the specific goods or services offered for sale within the advertisement. The network operations center also provides hyperlinks to web sites provided by the vendor or other e-commerce sites selling goods or services provided by the vendor. In this manner, the subscriber may browse information pertaining to advertisements of interest and perhaps purchase goods or services from the advertisers. In the example wherein the program segment is a request for a charitable donation, the network operations center provides information within the web site identifying the charitable organization and providing hyperlinks to web sites provided by the charitable organization for receiving donations or the like. In the example wherein the program segment contains an opinion poll, the network operations center may tally the results of the opinion poll and transmit the results to the broadcaster or other entity initiating the opinion poll and may additionally provide the results of the opinion poll within the web page accessible by the subscriber. Based upon the results transmitted to the broadcaster, the broadcaster can then quickly disclose the results of the opinion poll on the air for the benefit of those listening to the radio broadcast. For an implementation wherein only a single interactive radio button is provided, the subscriber responds to the opinion poll by pressing the single button at a specific time identified during the radio broadcast. For example, the broadcast disk jockey (DJ) may indicate that users wishing to enter a YES in response to the opinion poll should press their interactive radio buttons immediately, whereas users wishing to enter a NO in response to the opinion poll should wait until prompted by the DJ. Separate program segments are defined by the broadcaster specifying the two periods of response such that the specific time the subscriber presses the interactive radio button can be correlated with YES or NO, as appropriate. The handling of opinion poll responses using a system wherein the mobile units include multiple interactive radio buttons is described below.

One particular advantage of the system thus far described is that interactive capability is thereby provided in connection with conventional radio broadcast signals not requiring any additional information encoded therein, such as program segment identification information, broadcaster identification information, or the like. If the broadcast signal nevertheless includes encoded signals providing program segment identification information or the like, the system can exploit that additional information as well. An alternative implementation exploiting encoded broadcast signals is discussed below.

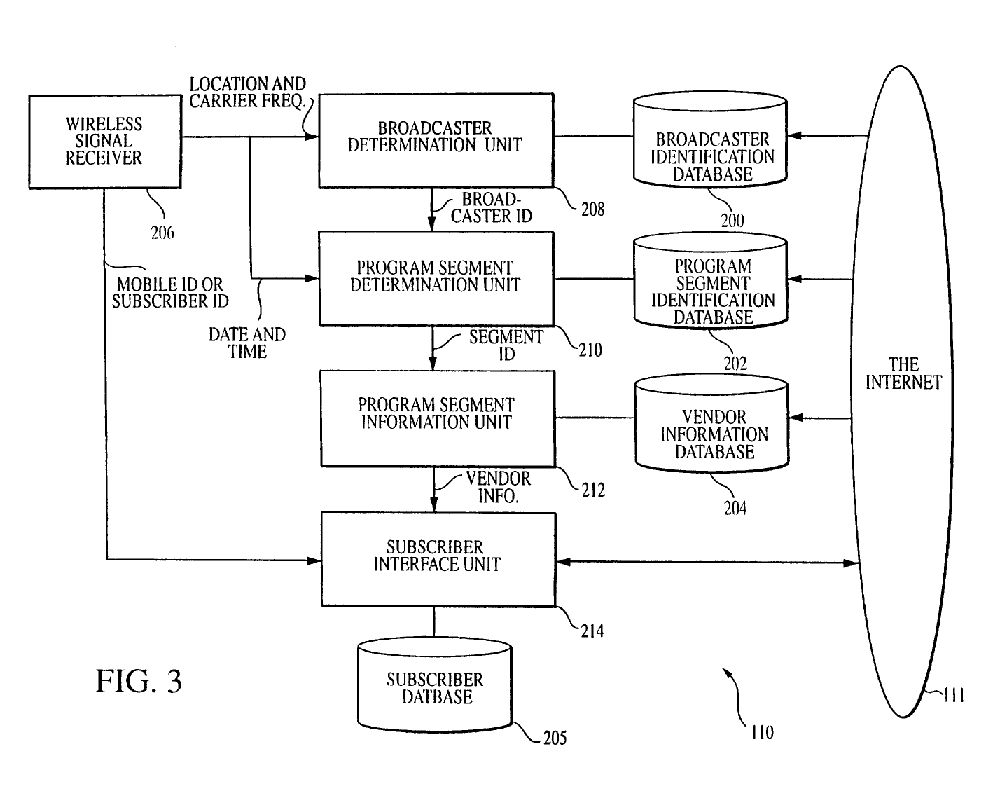

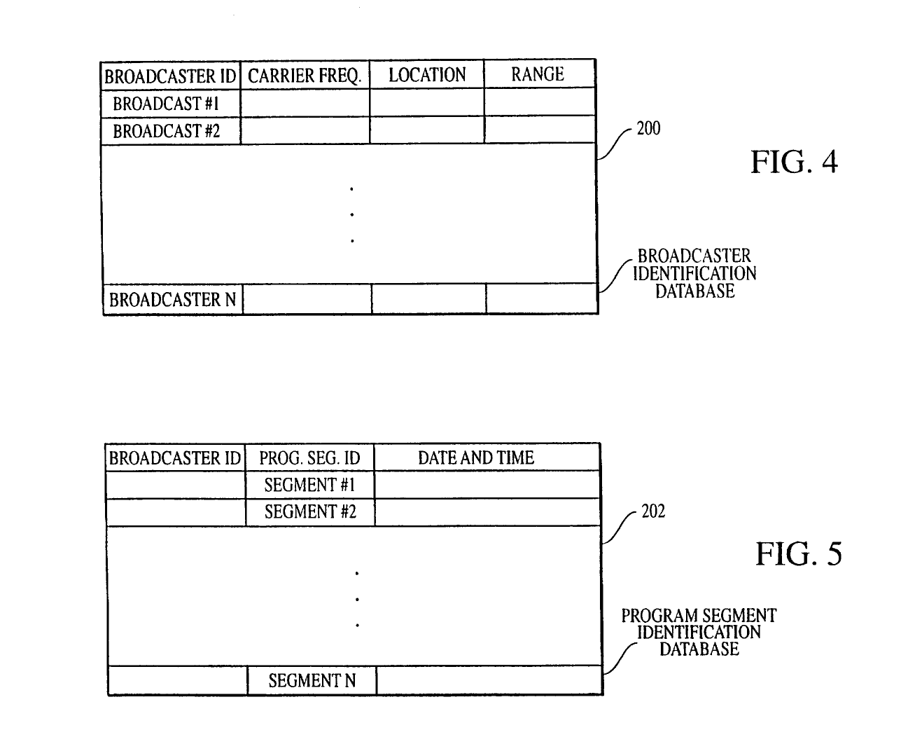

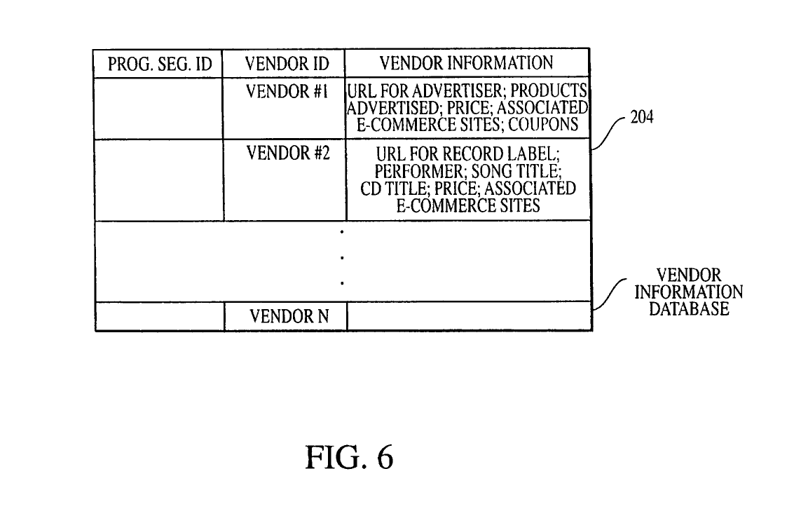

The operation of the exemplary system will now be further described with reference to FIGS. 3-6. The network operations center of FIG. 3 is pre-loaded with four databases containing information permitting identification of the broadcaster, the subscriber, program segments selected by the subscriber, and providing information pertinent to the selected program segments. Specifically, the network operations center includes a broadcaster identification database 200, shown more fully in FIG. 4, which provides, for each broadcaster affiliated with the system, a broadcaster ID, the carrier frequency of the broadcaster, the geographical location of the broadcaster, and a nominal geographical range for reception of signals transmitted by the broadcaster. The geographical location may be specified in terms of latitude and longitude. Alternatively, geographical location may be specified merely in terms of the general location of the broadcaster such as “Los Angeles” or “New York”. Optionally, the coverage maps of the broadcaster may be stored in digital form in the interactive mobile radio unit and compared to the position of the subscriber. For AM radio stations, the broadcast range may specify two values, one for daytime broadcasting and one for evening broadcasting. Note that some individual broadcasters will transmit multiple broadcast channels. If so, the broadcaster identification database provides geographic and frequency information pertaining to all of the channels broadcast by the broadcaster. The network operations center also includes a program segment identification database 202, show more fully in FIG. 5, which includes a program segment ID, the date and time of broadcast of the program segment, and the broadcaster ID for the broadcaster of the segment. The network operations center additionally includes a vendor information database 204, shown more fully in FIG. 6, which includes the program segment ID along with the identification of the vendor or other entity associated with the program segment and additional information associated with the vendor such as universal resource locator (URL) identifiers for e-commerce sites or other web sites associated with the vendor. The information stored within the broadcaster identification database and within the program segment identification database are received via the Internet from the broadcasters. The information provided within the vendor identification database may be provided either by the broadcasters or by individual vendors. Finally, the network operations center includes a subscriber database 205, which provides the subscriber name and password associated with each mobile unit or provides the e-mail address for the subscriber, such that the system can provide information corresponding to the selected program segments to the subscriber. The subscriber database may also provide a credit card number for the subscriber or other purchase authorization codes, such that the system can complete purchases on behalf of the subscriber or assess monthly or annual fees to the subscriber.

Referring again to FIG. 3, the interactive radio signals transmitted from the mobile unit to the network operations center are received by a receiver 206, which forwards the geographical location of the mobile unit as specified by the location attribute signal and the carrier frequency as specified by the broadcast attribute signal to a broadcaster determination unit 208. The broadcaster determination unit compares the geographical location and the carrier frequency with the information provided within the broadcaster identification database to identify the specific broadcaster associated with the received signal as represented by the broadcaster ID. The broadcaster ID is forwarded to a program segment identification unit 210, which also receives the date and time of the program segment as indicated within the broadcast attribute signal. In response, the program segment determination unit accesses information provided within the program segment identifier database to identify the specific program segment broadcast by the broadcaster at the date and time the program segment was received by the subscriber. Providing the date and time as part of the broadcast attribute signal permits the broadcast attribute signal to be transmitted subsequent to receipt of the program segment by the mobile unit but may require careful clock synchronization between the mobile unit and the network. Alternatively, the date and time is not transmitted as part of the broadcast attribute signal but is detected by the network operations center upon receipt of the broadcast attribute signal. Detecting the date and time at the network operations center eliminates possible clock synchronization problems between the mobile units and the network but may require the broadcast attribute signal to be transmitted substantially immediately by the mobile unit. In yet another alternative, relative time measurements may be utilized to account for any internal system delays.

In any case, once the program segment is identified, the program segment determination unit forwards the program segment ID to a program segment information unit 212, which accesses the vendor information database using the program segment ID to extract information provided by the vendor pertinent to the program segment which, as noted, may include web site addresses associated with the vendor as well as the names of goods or services offered by the vendor including, for example, song titles and the like. The information retrieved from the vendor database is forwarded to a subscriber interface unit 214, which also receives the subscriber ID for the subscriber of the mobile unit as specified by the subscriber identifier signal received by receiver 206. The subscriber interface unit then provides the vendor information to the subscriber either within a web page accessible by the subscriber and/or within individual e-mail messages transmitted directly to an e-mail account of the subscriber. To this end, the subscriber interface unit accesses subscriber database 205, which provides the subscriber name and password and the e-mail for the subscriber. The subscriber interface unit may also process purchase transactions directly on behalf of the subscriber using the stored credit card number for the subscriber.

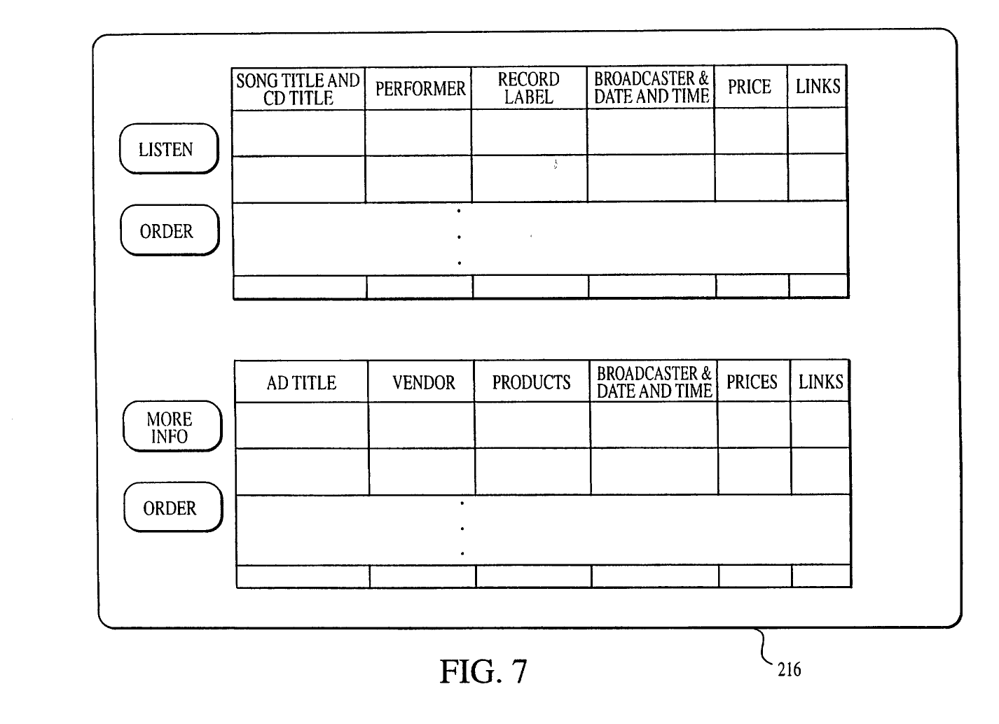

FIG. 7 illustrates an exemplary web page screen 216 accessible by the subscriber. As can be seen, information pertaining to various songs selected by the subscriber are provided including the title of the song, the name of the performer of the song, the radio station broadcasting the song and the date and time of day of the broadcast. Additionally, the web page provides a hyperlink to permit the subscriber to immediately download a digital version of a portion of the song for verifying that the song identified in the list was indeed the song listened to by the subscriber. Additionally, the web page provides links to e-commerce sites permitting the subscriber to purchase the CD in which the song appears or perhaps to create a customized CD containing the song or a customized digital music file. The web page also provides information pertaining to advertisements selected by the subscriber including the name of the vendor, the product advertised, the identity of the broadcaster, and the date and time of the advertisement. Along with each advertisement segment, the web page provides links to e-commerce sites maintained by the vendor or to other e-commerce sites through which the subscriber may purchase the goods or services advertised. Furthermore, when accessing information pertaining to subscriber identification signals through the Internet or other computer network, the subscriber may be presented with a window of selections both preceding and succeeding the generation of the subscriber identifier signal to accommodate both delays in generating the subscriber identification signal (i.e., the subscriber refrained from generating the subscriber identifier signal because of vehicular safety concerns) and imprecise time calculations (i.e., delays in communicating the subscriber identifier signal from the mobile unit 104).

Although not specifically shown, the web page provides numerous additional selectable interface buttons for navigating among various web pages provided by the system or for manipulating the information pertaining to the specific program segments such as, for example, to delete specific segments, to sort program segments either chronologically, alphabetically, or by other criteria, or to perform other functions. Additionally, the web page may include advertising banners advertising goods or services. The specific advertising banners presented to the subscriber within the web page may be correlated with the various program selections made by the subscriber. For example, if the subscriber has selected a number of songs within a particular genre of music, the banner advertisements may be directed to additional e-commerce sites relevant to that genre of music.

The information provided within the web page is accessible using any suitable Internet access technique, including access via PDAs or other portable devices capable of downloading and displaying Internet web pages. In this regard, the mobile unit itself may be provided with Internet access, via the wireless communication system, such that information provided within the web page can be accessed by the subscriber contemporaneously while listening to the radio broadcast during which the various program segment selections are made. Although not specifically shown, similar information may be provided within e-mail messages transmitted directly to the subscriber.

In addition to providing information to the subscriber based upon program segments selected by the subscriber, the system may provide information to the broadcasters pertaining to the various subscribers listening to their broadcast or to the vendors associated with program segments selected by the subscribers. For example, whenever a subscriber selects a program segment broadcast by a particular broadcaster, information identifying the program segment, the date and time of day, the subscriber, and the location of the subscriber are forwarded to the broadcaster such that the broadcaster may develop statistical profiles based upon the information. In one specific application, if the broadcaster determines that subscribers are mostly located in a particular geographical location, then the broadcaster may specifically target advertisers based in that geographical location. As another example, whenever subscribers select a program segment containing an advertisement, information pertaining to the particular advertisement, date and time of day, the subscriber, and the location of the subscriber are forwarded to the advertiser such that the advertiser may develop statistical profiles based upon the information. As can be appreciated, a wide range of information may be provided to broadcasters or vendors to permit those entities to better serve the needs of the various subscribers.

Thus, with reference to FIGS. 1-7, a system has been described which automatically determines the particular program segment selected by the subscriber based upon the geographical location of the mobile unit of the subscriber as determined by, for example, GPS, the carrier frequency of the broadcaster, and the date and time the broadcast was received. Hence, the system operates effectively with conventional AM or FM radio broadcasts. If implemented in connection with broadcasters broadcasting digital radio signals, the digital radio signals are preferably encoded with signals identifying the broadcaster and the specific program segment being transmitted. If so, the system need not identify the broadcaster based upon the carrier frequency and geographical location. Rather, the network operations center directly accesses the program segment and vendor information databases based upon the program segment identified by the digital radio signals to retrieve information associated with the program segment selected by the subscriber. Moreover, if the mobile unit is provided with a graphic display, the program segment information provided within the broadcast radio signal may be displayed using the graphic display to the subscriber. If the subscriber wishes to obtain additional information pertaining to the program segment, the subscriber presses the interactive radio button causing the system to ultimately provide the additional information via the Internet to the subscriber for subsequent browsing.

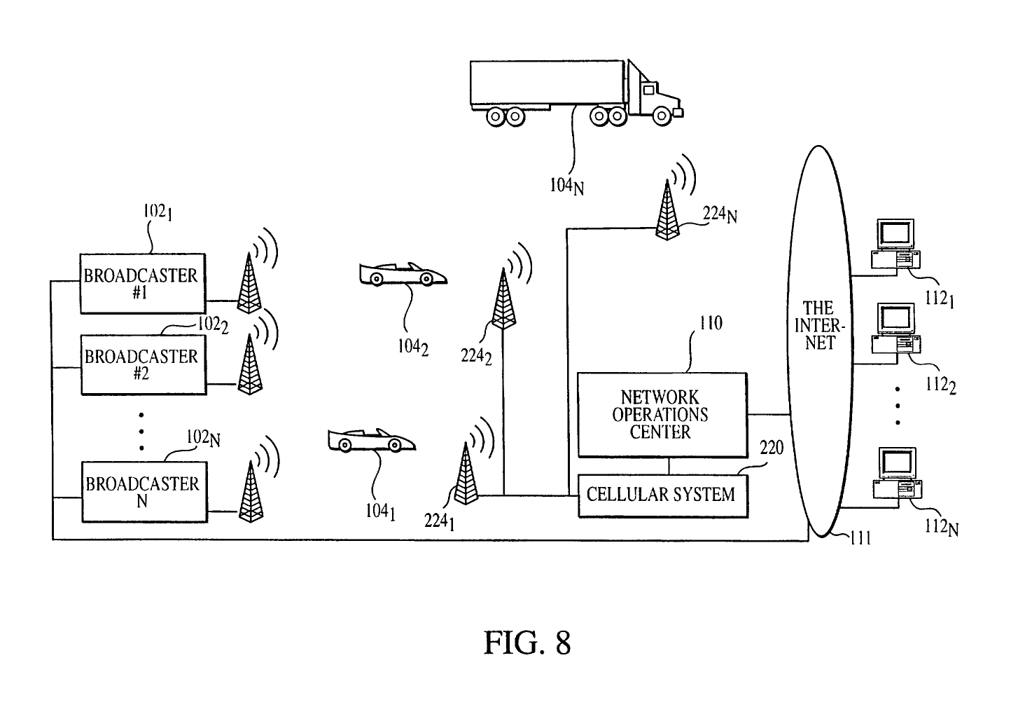

In an alternative implementation, shown in FIG. 8, the system is configured using a cellular telephone system 220 rather than a satellite wireless communications system. The approximate geographical location of the mobile unit may be identified based upon the base station of the cellular system 224 receiving the wireless transmission from the mobile unit. Alternatively, the location may be determined by the cellular system using radio triangulation techniques. An identification of the geographical location of the base station is forwarded to the network operations center along with the various interactive radio signals received from the mobile unit. The network operations center then determines the identity of the broadcaster based upon the carrier frequency of the broadcast and the geographical location of the cellular base station. Hence, no GPS system or other geographical location determination unit is required as part of the mobile unit.

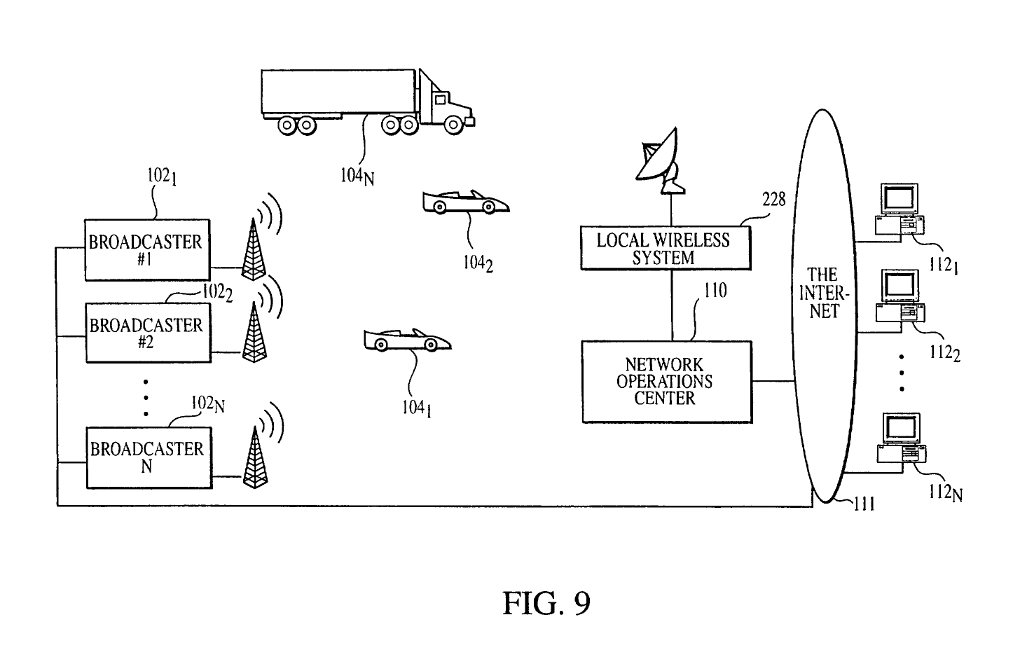

In another implementation, shown in FIG. 9, the system is implemented within a single geographical area using a dedicated localized wireless communications system 228 maintained by the interactive radio network, such that the network operations center can identify the broadcaster based solely upon carrier frequency rather than upon the carrier frequency and geographical location of the mobile unit. Hence, the geographical location of the mobile unit need not be determined either by GPS, cellular base station location or other means. Also, the broadcaster identification database need not identify the geographical location of the broadcaster or its range. Moreover, since a dedicated localized wireless communication system is employed, the system need not employ either a cellular telephone system or a satellite wireless communication system.

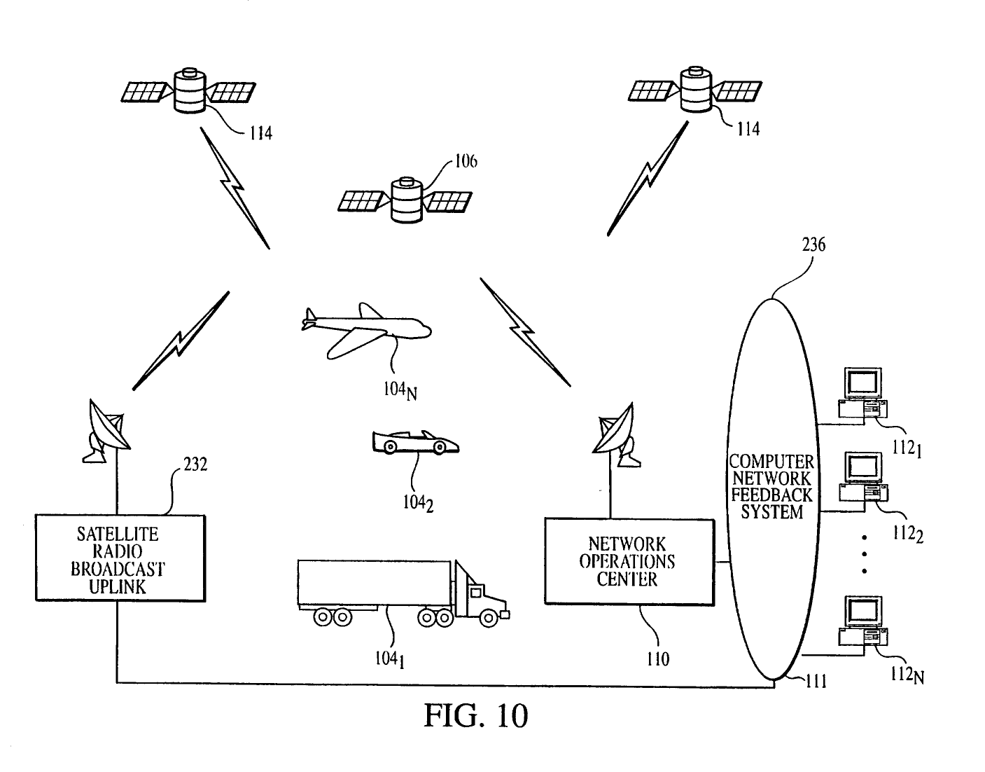

In yet another implementation, shown in FIG. 10, the system is implemented using a satellite radio broadcast system 232 rather than land-based broadcasters. The various implementations illustrated in FIGS. 1-9 may also be configured for use with satellite radio broadcasts. Typically, a satellite broadcaster will transmit multiple radio channels using a single carrier frequency with digital information encoded therein identifying the different channels. When used in conjunction with satellite systems broadcasting multiple channels per carrier frequency, the interactive radio system determines the identity of the particular broadcaster based upon both the carrier frequency and the digital information identifying the broadcast channel. Depending upon the implementation, the mobile unit may be configured to extract the digital information from the received signal along with the carrier frequency for forwarding to the network operation center. In other implementations, the mobile unit generates a broadcast attribute signal which includes a portion of the received satellite broadcast signal such that the network operation center can extract the channel identification information and determine the identity of the particular channel. Terrestrial radio broadcasters may also provide multiple channels per carrier frequency and similar techniques are employed as well for determining the identity of the broadcaster associated with the particular channel being listened to by the subscriber. One particular multiple channel/single carrier system is the Eureka 147 system.

FIG. 10 also illustrates that feedback to the subscriber may be provided through other computer network feedback systems 236, besides the Internet. One example of an alternative computer network feedback system is an intranet system or other local, regional, or dedicated computer network system accessible by the subscriber.

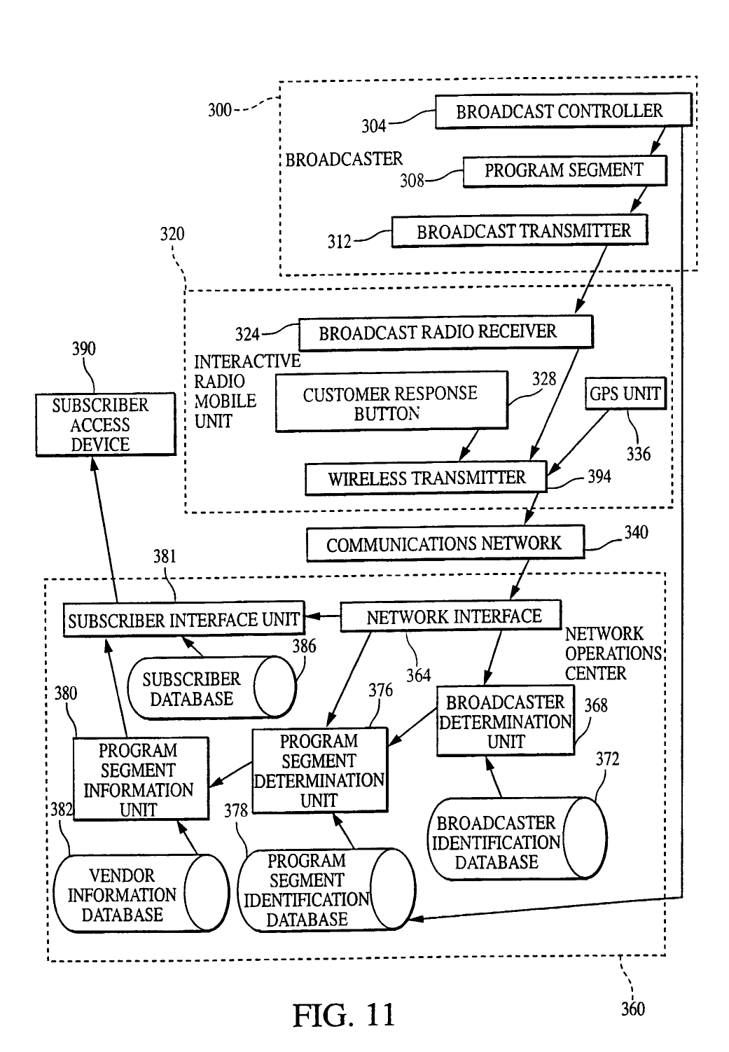

Illustrated in FIG. 11 is a further embodiment comprising a broadcaster 300 that broadcasts signals to be received by an interactive radio mobile unit 320. The mobile unit upon the depression of a customer response button 328 (or other actuation means such as voice activation, etc.), may transmit a subscriber command signal to be received by a communications network 340 that is coupled to a network operations center 360 which is in turn coupled to a subscriber access device 390.

A broadcast controller 304 such as a disc jockey or automated radio station equipment within the broadcaster 300 initiates a program segment 308, such as those described in connection with the program segment database 202 that contain an identifiable audio source (i.e. recording, live performance, or commentary), to begin playing. The underlying information pertaining to the program segment may be manually entered, or it may be stored in digital memory associated with the program segment to update a program segment identification database 378 (described below). The audio from the program segment, as well as any embedded information, if any, is then fed into a broadcast transmitter 312 to transmit the program segment to be received by the interactive radio mobile unit 320. As stated above in connection with other embodiments, this transmission may be a conventional AM/FM broadcast, a television broadcast, an Internet data transmission, a terrestrial digital audio broadcast (DAB), a satellite digital audio radio broadcast (SDARS), a high-definition television broadcast (HDTV), or any other type of digital or analog broadcast which includes an audio or video component.

The program segment 308 transmitted by the broadcaster 300 is received by a broadcast radio receiver 324 within the interactive radio mobile unit 320. The receiver is coupled to the customer response button 328 similar to the interactive radio control button described above, and to a wireless transmitter 332. When the customer response button is depressed thereby generating a subscriber command signal, the frequency at which the receiver was tuned (for other non-broadcast systems such as Internet data transmissions, other identifiers associated with the source of the transmission may be sent such as URLs, etc.) to when the subscriber command signal was generated is sent to the wireless transmitter. In some embodiments, the interactive radio mobile unit may include a positioning device such as a GPS unit 336 that determines and sends the position of the interactive radio mobile unit and the absolute time to the wireless transmitter when the subscriber command signal is generated. The wireless transmitter, in turn, transmits a subscriber command signal containing the received carrier frequency from the broadcast radio receiver, the position of the mobile unit (if a positioning device is incorporated into the mobile unit), and the time at which the subscriber command signal was generated to be received by the communications network 340. In addition, further identification information may be included in the subscriber command signal such as the serial number of the mobile unit, and/or personal information regarding to the subscriber such as telephone numbers, billing and shipping addresses, and credit card numbers. The wireless transmission and the communications network may be of any sort, such as SMS, PCS, GSM, CDMA, CDPD, satellite-based data, or WAP.

In embodiments not employing a positioning device 336 such as GPS, the communications network 340 may append to the subscriber command signal the location of the interactive radio mobile unit 320 as determined by the communications network (i.e., via the location of a cell antenna). The communications network may also append additional account information regarding the subscriber and/or information regarding the time at which the subscriber command signal was received by the communications network.

The communications network 340 is coupled to the network operations center 360 (either wirelessly or through a wired connection) and forwards the subscriber command signal (or a portion thereof) to a network interface 364 in the network operations center. Information contained within the subscriber command signal pertaining to the carrier frequency and the position of the interactive radio mobile unit 320 when the subscriber command signal was generated is sent to a broadcaster determination unit 368. The broadcaster determination unit 368 then associates such information with a specific broadcaster 300 contained within a broadcaster identification database 372. The broadcaster determination unit then sends identification information associated with the specific broadcaster to a program segment determination unit 376.

In addition to receiving the identification of the specific broadcaster 300, the program segment determination unit 376 receives the time at which the subscriber command signal was generated from the network interface 364. The broadcaster identification and the time from the subscriber command signal are then associated with a specific program segment 308 stored within a program segment identification database 378. The program segment identification database contains a table of times during which the program segments 308 were broadcast (i.e., the song “My One and Only Love” by John Coltrane and Johnny Hartman was played on Monday, Nov. 20, 2000 from 12:52 p.m. and 43 seconds to 12:57 p.m. and 27 seconds), as well as a unique identification for each program segment. The program segment identification is then sent to a program segment information unit 380 which extracts information associated with the program segment from a vendor information database 382 (i.e., information pertaining to an advertisement or information pertaining to a music order fulfillment company). This extracted information is then sent to the subscriber interface unit 381 which receives a subscriber identification code (i.e., serial number of the interactive radio mobile unit 320 or other information sufficient to either identify the subscriber and/or the interactive radio mobile unit) from the network interface 364. The subscriber interface unit is further coupled to a subscriber database 386 which associates the subscriber command signal with a specific subscriber and a communication gateway to the subscriber. Information pertaining to the program segment as extracted from the vendor information database may then be made available on the subscriber access device 390 which may be a computer, a PDA, a WAP phone or other device with a wired or wireless connection to the Internet or other computer network. In this embodiment, the broadcast controller 304 which determines which program segment to transmit, is coupled to the program segment identification database such that a table of program segments and the time they were played is created for each broadcaster. As many broadcasters, such as radio stations, already have data logging systems monitoring the broadcasted program segments, the current invention may be implemented by accessing this information through a remotely accessible server in communication with the data logging systems.

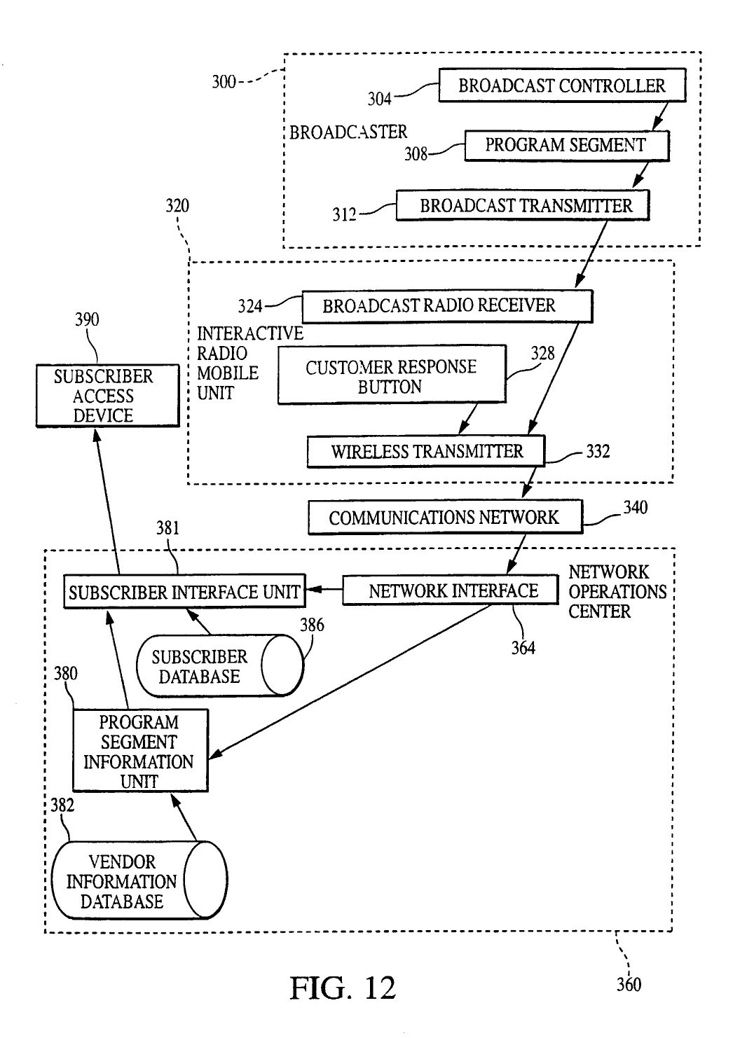

FIG. 12 illustrates an alternative embodiment to that described in connection with FIG. 11 wherein the broadcasts by the broadcast transmitter 312 contain embedded information identifying the program segment 308 being broadcast. This embedded information may be included on a separate channel such as described in the Noreen patents, in the same digital channel, or alternatively be embedded by the convention utilized by RBDS or in another subcarrier signal such as the techniques described in U.S. Pat. No. 5,699,433, which is hereby incorporated by reference. As the subscriber command signal contains sufficient information to identify the underlying program segment 308, the network interface 364 is coupled directly to the program segment identification unit 376 thereby obviating the need to access a broadcaster identification database and program segment determination unit.

In addition, the embodiment of FIG. 12 may also be utilized to notify subscribers of the interactive radio mobile unit 320 whether information relating to the underlying program segment 308 is available to the subscriber should he or she generate a subscriber command signal. For example, a signal (such as a sawtooth, square wave or other identifiable signature) at a certain non-audible frequency may be transmitted such that when it is received by the broadcast receiver 324, an LED or other interface mechanism on the interactive mobile radio unit may be activated to notify that enhanced radio broadcast services are available for that program segment. Alternatively, if the program segments are digitally broadcasted, a Boolean indicator may be incorporated to trigger one of the above notification mechanisms.

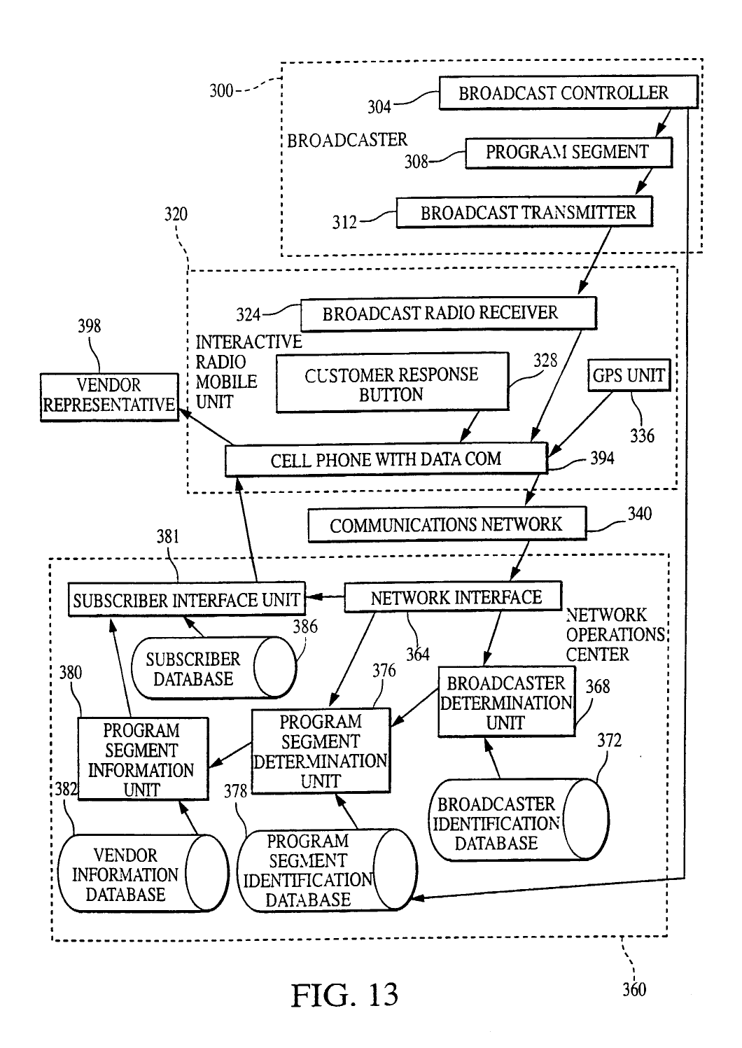

FIG. 13 illustrates an embodiment in which the generation of the subscriber command signal by the subscriber by activating the customer response button 328 initiates a communication gateway between the subscriber and a vendor representative 398. The communication gateway may be a telephonic connection, telephony, short band radio, video conferencing or an equivalent thereof so long as an appropriate communication gateway identifier is available to connect the vendor representative to the subscriber (i.e., telephone number, URL of an IP-based telephone system). This embodiment further includes a cellular (mobile) phone 394 which acts as the wireless transmitter as discussed in previous embodiments, and also provides a communication gateway between the subscriber and the vendor representative. In operation, when the subscriber depresses the customer response button, the frequency, the time (as calculated either through a GPS system or other standardized clock system), and the position of the interactive mobile radio unit 320 (as calculated either through a terrestrial triangulation system, GPS, or through the position of the receiving antenna in the communications network 340) are sent to the network operations center 360 which in turns sends a signal to the cellular phone to initiate a communication gateway (such as a telephone call) with the vendor representative. This may be accomplished by sending a signal to automatically dial the cell phone to a specific telephone number. In addition, the subscriber interface unit 384 may be coupled to the vendor representative 398 so that when a communication gateway is initiated, the vendor representative is provided with account information regarding the subscriber as well as program segment information identifying the program segment 308 of interest. For example, when a communication gateway is initiated, the vendor representative would be able to address the subscriber by name, inquire whether they wished to purchase the underlying item or service in the program segment, and then confirm the account information provided by the subscriber interface unit. Alternatively, the current invention may provide for automatic initiation and completion of telephone conversations, or it may provide the subscriber with the communication gateway identifier (i.e., the telephone number is later provided so that the subscriber may place a telephone call at his or her convenience).

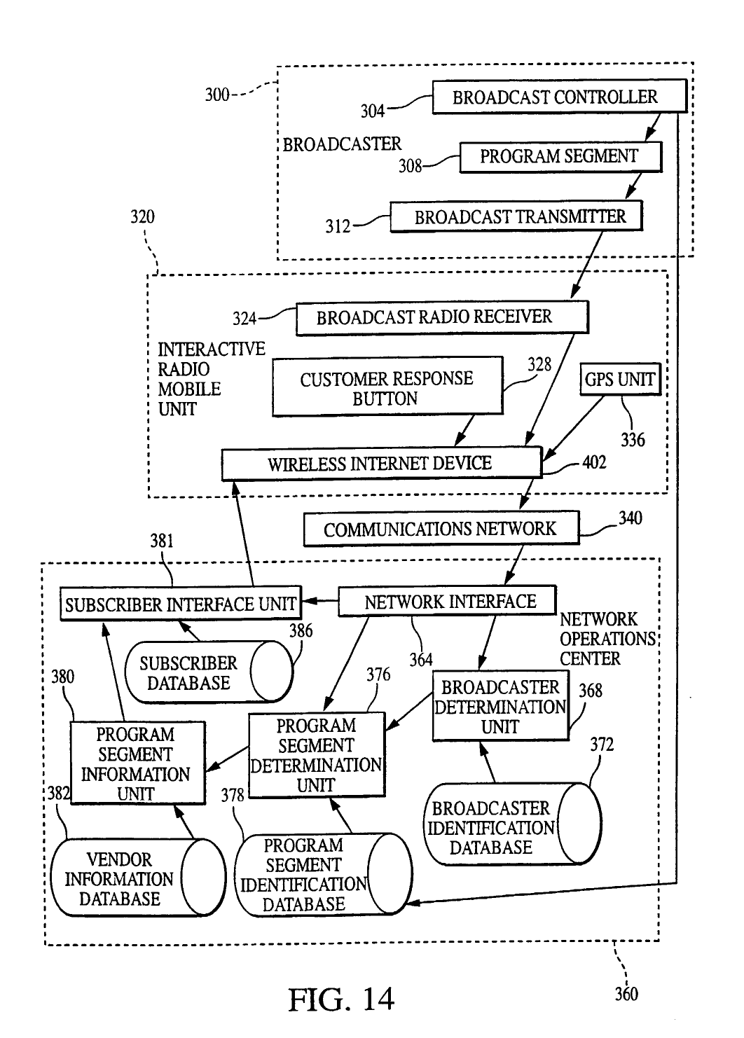

FIG. 14 illustrates another embodiment in which the interactive mobile radio unit 320 has a wireless Internet device 402 that communicates with the network operations center 360 through a communications network 406 using a wireless Internet device such as a WAP-enabled phone through a packet data network such as CDPD networks. In such an arrangement, information pertaining to the program segment may be displayed on the wireless Internet device. Specifically, underlying information such as a song title or the contact information for a vendor may be displayed in real time (or near to real time) while the program segment is being broadcast. In addition, the generation of a subscriber command signal may also be used to provide additional information such as location of nearby items or services relating to a program segment. For example, if the program segment pertained to a fast food chain and a subscriber command signal is generated, and the position of the interactive radio mobile unit is known (either through GPS or based on the location of received signals within the communications network), then the address and/or directions to the nearest restaurant in that chain may be made available on the wireless Internet device. In addition, if the wireless Internet device is coupled to a navigational system, such as with an Auto PC, then the address of the nearest restaurant (or a choice of restaurants within a predefined geographical area) may be communicated to the navigation system to allow the subscriber to use such navigation system to find the desired restaurant. Further discussion of position based vendor information is described below.

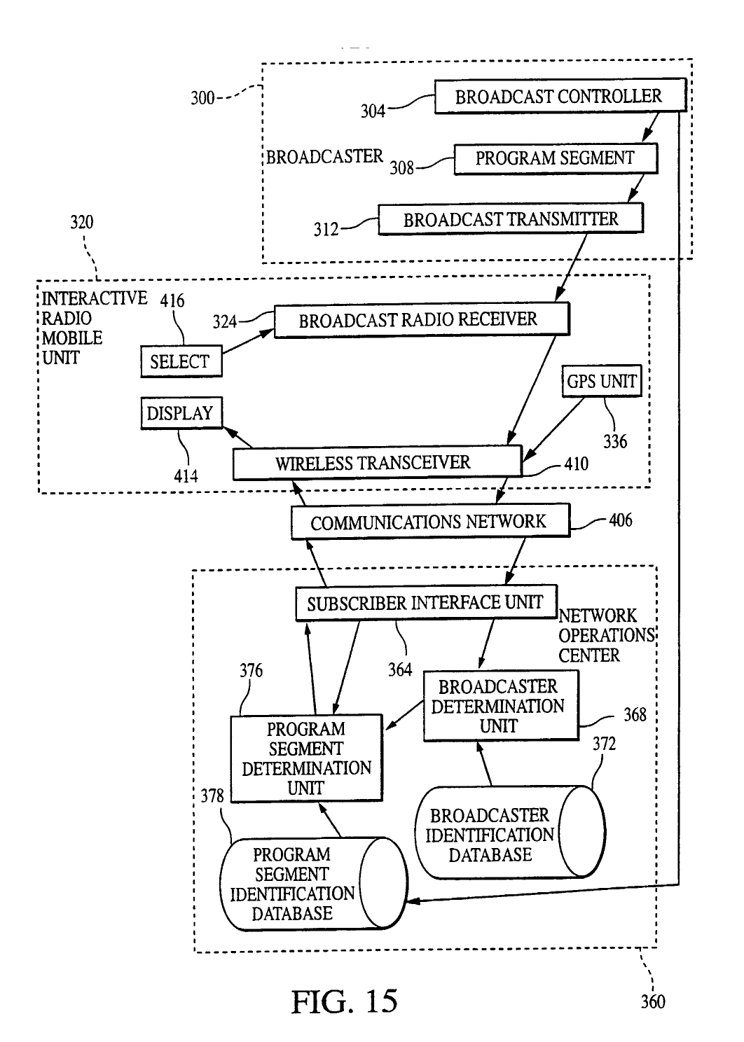

Now with reference to FIG. 15, a system is shown in which information regarding program segments and/or broadcasters (or an unrelated advertisement) is periodically updated and made available to the subscriber via a display 414. Specifically, in this embodiment, a wireless transceiver 410 in the interactive mobile radio unit 320 may be in communication with the network operations center 360 via the communications network 406. The wireless transceiver is coupled to the broadcast radio receiver 324, the display, and the GPS unit 336 such that periodically either at set intervals, whenever the subscriber changes the carrier frequency on the interactive radio mobile unit, or by subscriber request, a subscriber command signal is sent to the network interface 364 containing the frequency that the interactive mobile radio unit is tuned to as well as the position of the mobile radio unit (as stated above, position may also be determined by the location at which the wireless network receives subscriber command signals from the wireless transceiver). The network interface in the same manner as described above, then generates a signal pertaining to information relating to the broadcasted program segment. This signal is received by the wireless transceiver and the underlying information is then made available to the subscriber via the display. For example, enhanced information such as the current artist and song title may be displayed as well as the next and last songs. In addition, lists of local radio stations and formats may be displayed (or other variations of playlists or vendor information). The different types of enhanced information may be made available on the display by actuation of a select button 416 which is part of the interactive mobile radio unit. Alternatively, the select button may be used to select one of the local stations, upon which action the broadcast radio receiver would be automatically tuned to the selected station.

In addition, a list of local radio stations may be displayed through use of an integrated broadcaster identification database stored within the mobile unit. Such an arrangement removes the requirement for communication with the network operating center when the location of the mobile unit is known. In this case, the list of local radio stations is generated by extracting all broadcasters whose coverage areas include the current location of the mobile unit from the integrated broadcaster identification database. The mobile unit may then display a list of such local broadcast stations, and the subscriber may then select one such station for the radio to be tuned to through a selection unit. Upon such selection, the broadcast radio receiver will be tuned to the frequency associated with the selected broadcaster. The location of the mobile unit may be manually input into the mobile unit by the subscriber, or it may be determined by a GPS unit within the mobile unit or by some other means.

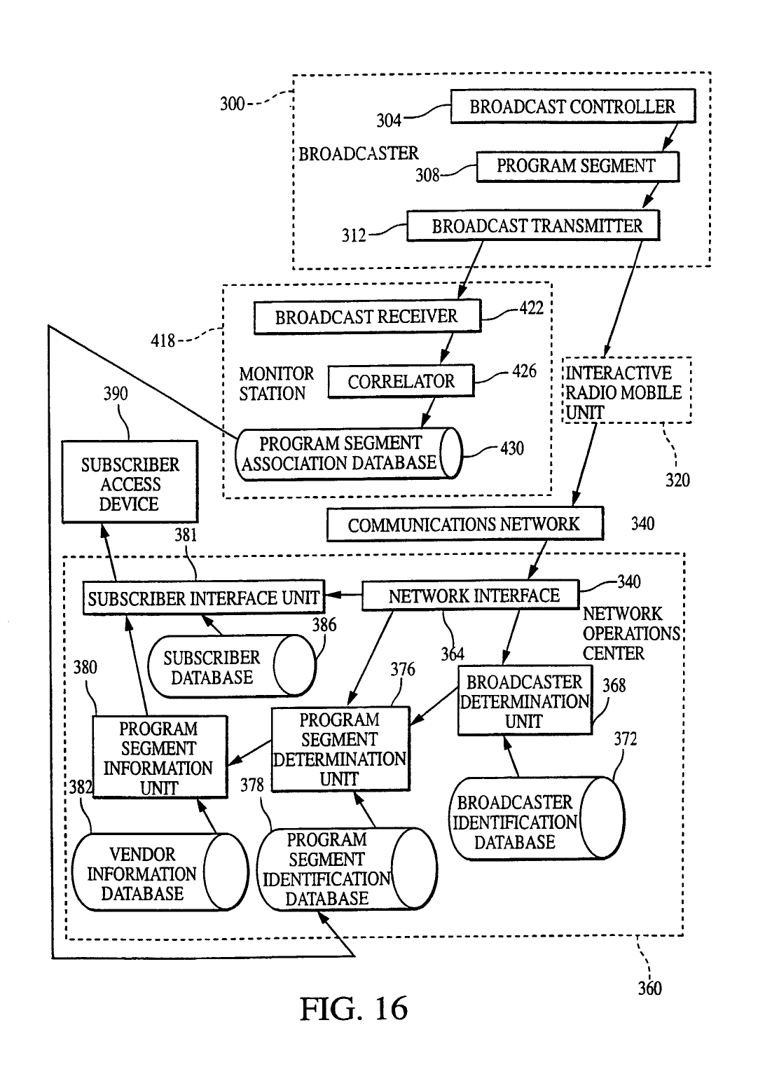

FIG. 16 illustrates an embodiment in which a monitor station 418 is utilized to provide information for the program segment identification database 378. Specifically, when signals are broadcast from the broadcast transmitter 312, a broadcast receiver 422 within the station monitor receives such signals and sends such signals to a correlator 426. The correlator is in turn coupled to a program segment association database 430. The correlator associates the broadcast signals received by the broadcast receiver with the particular program segment 308. The monitor station may be part of a monitoring system such as those offered by companies such as BDS. Preferably, the program segment association database is populated with information pertaining to the program segment prior to the broadcast of the program segment by the broadcast transmitter so that the signals may be associated in real time (or near real time).

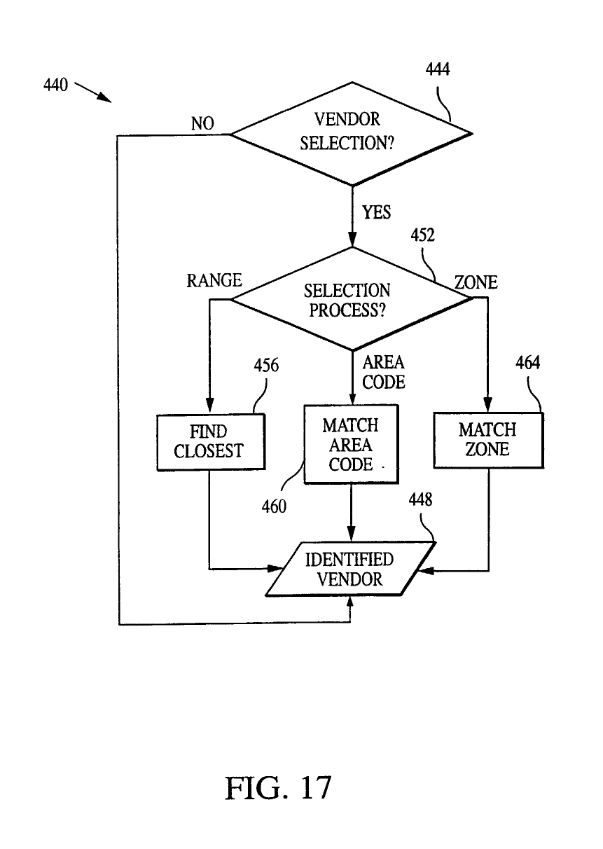

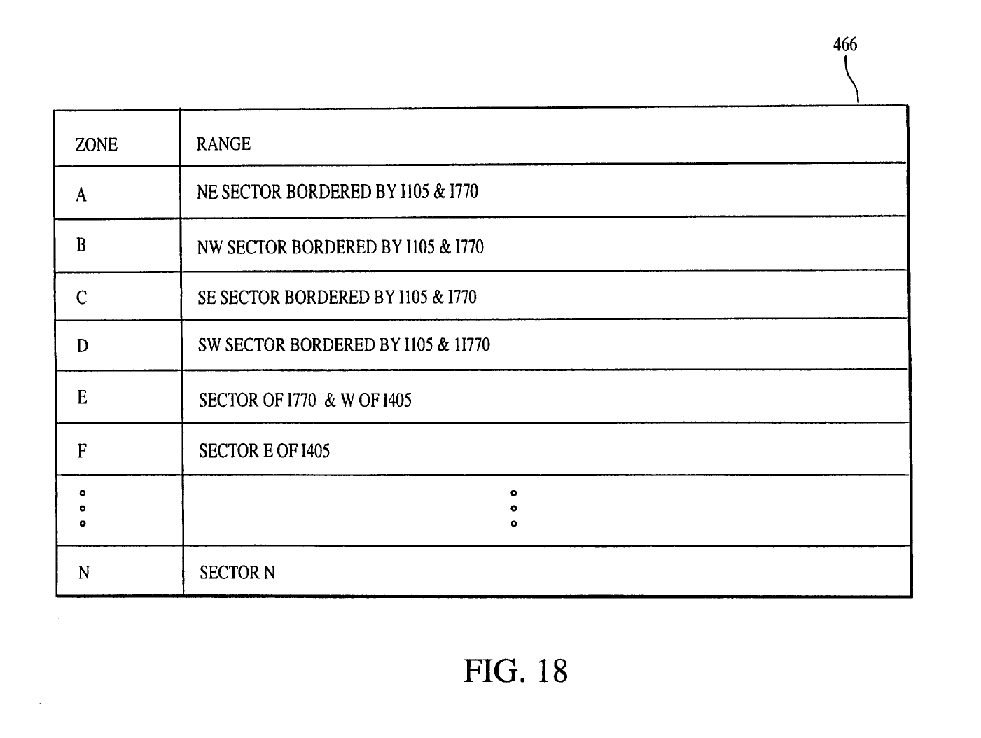

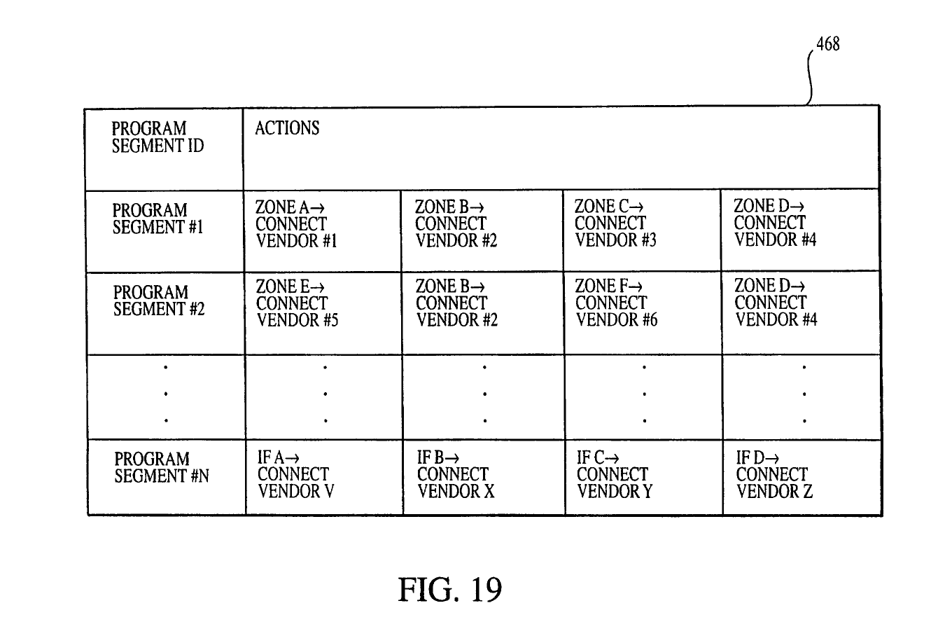

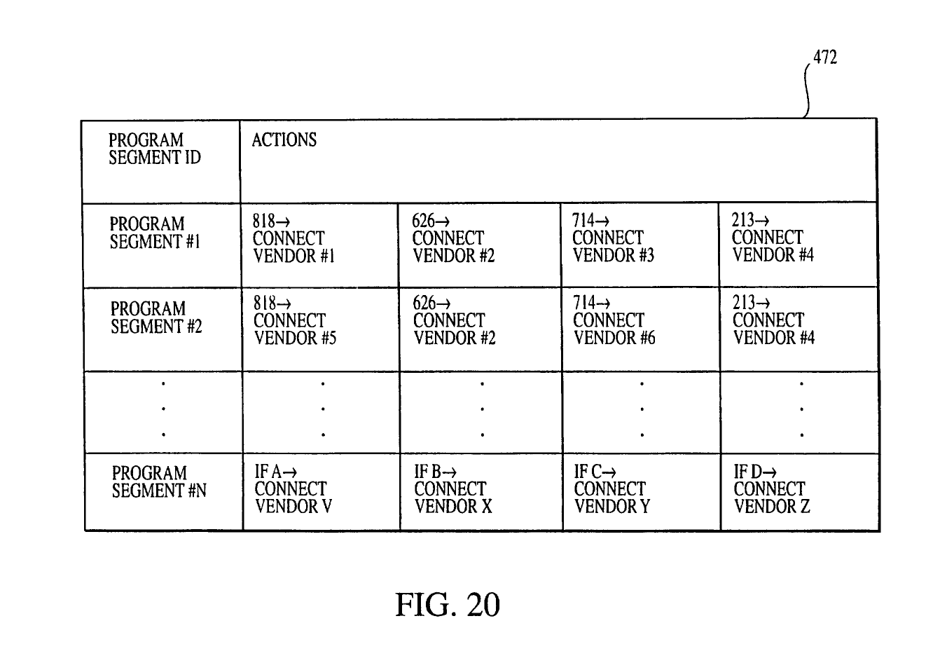

It will be appreciated that information pertaining to a program segment 308 may be tailored to the position of the interactive radio mobile unit 320 when the customer response button 328 is depressed. As stated above, navigational instructions guiding the subscriber of the interactive radio mobile unit to a specific location may be utilized. To effect such position specific content, information extracted from the program segment identification database 378 may be organized by regional zones or the nearest location(s) may be displayed to the subscriber. One exemplary flow diagram 440 is illustrated in FIG. 17. Initially, the system must determine if the program segment is applicable to all subscribers regardless of their position (i.e. a song on a radio or an advertisement pertaining to a website) through a vendor selection query 444. If the program segment is universally applicable to all subscribers, then vendor information associated with the vendor is identified 448. If not, then a selection process query 452 is initiated to determine if the vendor information associated with the vendor is dependent upon range, area code, or by zone. If the vendor information is dependent upon range, then the closest one or more vendor locations are identified 456 (i.e., if the program segment is an ad pertaining to a chain of restaurants, then the locations and additional information such as special offers and driving directions, is provided for at least one nearby vendor). If the vendor information is dependent upon either the area code of the number on the communications network 340 or the area code in which a communications portal (i.e., cell) is located (see FIG. 20), then vendor information associated with that area code is identified 460 and later provided to the subscriber via the subscriber access device 390. Finally, if the vendor information is arranged by predetermined geographic zones, then information about one or more vendor associated with the zone in which the interactive mobile unit 320 is located 464 is provided to the subscriber via the subscriber access device. FIG. 18 illustrates a zone database 466 in which a plurality of zones with specific geographic boundaries are stored. This zone database may be used to associate vendor information within the vendor information database 382 with a specific zone or region. For example, the zones may be organized by state so that information subsequently provided via the subscriber access device 390 is specific to the state in which the interactive mobile radio unit 320 received the broadcast program segment 308. In addition, and as enumerated by FIG. 18, the zones may also be organized via other methods such as freeway boundaries, user preferences, zip codes, counties, etc. Once a zone is identified, the program segment associated with that zone must be identified using a database such as a program segment-zone database 468 illustrated in FIG. 19. Alternatively, and as described in connection with FIG. 17, the program segments may be associated with specific area codes as shown in a program segment-area code database 472 in FIG. 20.

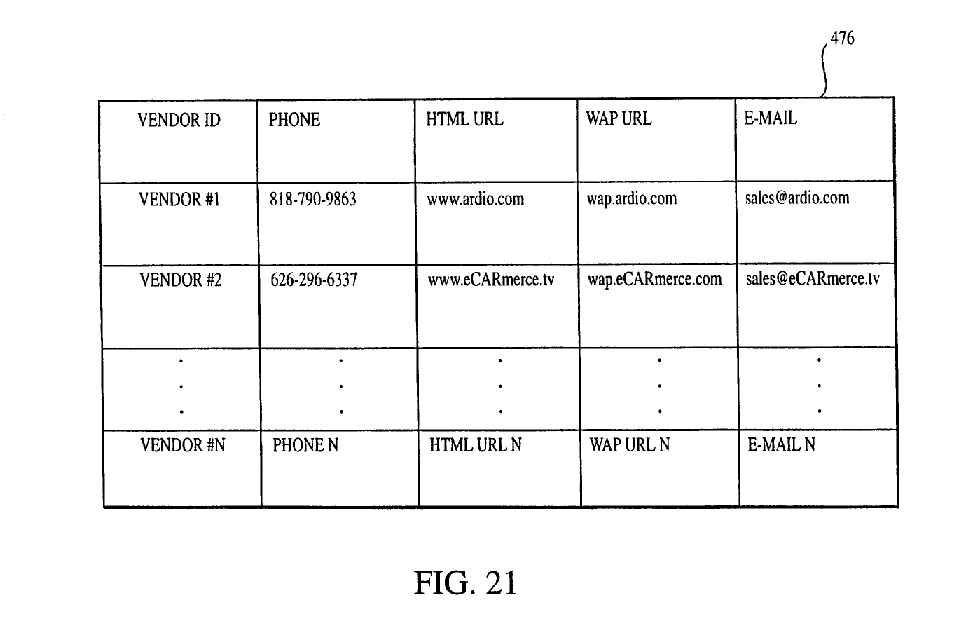

In addition to the provision of location specific vendor information, information tailored to the particular subscriber access device 390 may be utilized. For example, a program segment-subscriber access device database 476 as shown in FIG. 21 may be incorporated into the vendor information database 382 to provide information appropriate for the subscriber's subscriber access device. For example if a WAP-enabled mobile phone is used, then the generation of a subscriber command signal may point a browser within the phone to a URL tailored for WAP phones. Alternatively, the vendor information may include a telephone number to connect the subscriber with a representative of the vendor, a URL with an html web page, or it may provide other information such as a e-mail address, or an mpeg file containing a multimedia advertisement (not shown). This arrangement is preferred in that it will allow a subscriber to always obtain information regarding a program segment in a user-friendly manner. For example, a subscriber may utilize multiple subscriber access devices such as a computer, a PDA, and a WAP-enabled phone, and for each of these access devices, information tailored to that specific device may be provided to enhance the subscriber's experience.

As noted above, the mobile unit may be provided with multiple buttons or other input mechanisms for receiving various commands from the subscriber. If so, the mobile unit preferably also transmits to the network operation center a subscriber command signal, which identifies the particular button or buttons pressed by the subscriber or which otherwise identifies specific commands entered by the subscriber. In one specific example, the mobile unit may include an alpha-numeric keypad for receiving text based commands from the subscriber with the commands being transmitted to the network operation center and processed therein. In another specific example, the mobile unit may be provided with a set of predefined interactive radio buttons with, for example, a first button designated as an “INFO” button and a second button identified as a “ORDER” button. If the subscriber merely wishes to receive additional information pertaining to a program segment, the subscriber presses the INFO button. An INFO command is forwarded along with various other signals to the network operation center which, in response thereto, provides information corresponding to the program segment to the subscriber via the Internet. On the other hand, if the subscriber is certain that he or she wishes to immediately purchase the goods or services offered for sale via a broadcast radio segment, the subscriber presses the “ORDER” button and an ORDER command is forwarded to the network operation center. In response thereto, the network operation center immediately processes the purchase on behalf of the subscriber. The ability to immediately enter a purchase command is particularly desirable for use with special time-limited product offers, such as may be provided within interactive radio shopping channels and the like. Thus, the subscriber can immediately purchase goods or services to ensure that the goods or services do not sell out and to ensure that the price does not subsequently change. Also, in response to radio opinion polls, the subscriber may be invited by the DJ to press the first button to enter a YES response and the second button to enter a NO response. Moreover, in response to product offers, the subscriber may be invited by the advertiser to press the first button to select product A and the second button to select product B. Hence, multiple-choice responses are accommodated. In another specific implementation a single interactive radio button is provided in combination with conventional radio station preset buttons 125. During normal operation, pressing one of the preset buttons re-sets the radio to receive broadcasts from the radio station associated therewith. However, by pressing the interactive radio button immediately prior to pressing one of the preset buttons causes the mobile unit to interpret the preset button in accordance with a specific predetermined interactive radio command, such as an INFO or ORDER command. It will be appreciated that a variety of different mechanisms to generate wireless signals from the mobile units may be incorporated.

It will also be recognized that certain accommodations may be made with the current system to account for any delayed generation of subscriber command signals as well as errors due to radio signal interference. For example, when information pertaining to a particular vendor is displayed on a subscriber access device, the subscriber will have the option to access vendor information for preceding and succeeding program segments. In addition, if a subscriber is traveling between to cities with overlapping or interfering broadcasts, the vendor information associated with a program segment may not always be accurate, and so the subscriber will also have the option to access vendor information in a plurality of markets for simultaneously broadcast program segments.

As can be appreciated, numerous other implementations are consistent with the general principles of the invention. For example, mobile units may also be provided for use in trains, airplanes, ferries, buses and the like. Systems employing non-mobile units may also be provided. Non-mobile units may be installed in individual homes or offices, retail centers, retail kiosks, Cyber-cafes, Internet boutiques or the like.

Furthermore, it will be appreciated that there are many different devices that may be used to transmit signals in response to the generation of a subscriber command signal out of the interactive radio mobile unit. For example, the mobile unit may utilize Bluetooth components or infrared components to allow it to transmit and receive wireless signals via a mobile phone or a wireless Internet device thereby obviating the need for an integrated transceiver.

Preferably, the overall system is configured to work in combination with a variety of types of broadcasters including conventional AM or FM broadcasters, digital radio broadcasters, IBOC, Eureka 147, satellite broadcasters (such as those to be provided by companies such as XM Radio, Sirius Radio, and Worldspace) and the like. The system also preferably works in cooperation with a variety of wireless transmission systems including mobile satellite wireless systems, cellular systems, localized dedicated wireless transmission systems and the like. Depending upon the originating broadcaster and depending upon the mode of wireless transmission, different types of information are received by the network operations center from mobile units, broadcasters etc. The network operations center parses the information received, determines which databases need to be accessed, and provides the requested feedback to the subscriber.

The overall system may also provide rating information pertaining to broadcast program segments. For example, the interactive radio mobile unit may periodically either at set intervals, whenever the subscriber changes the carrier frequency on the interactive radio mobile unit, by subscriber request, or at the request of the NOC or the advertiser, send a wireless signal to the network interface containing the frequency that the interactive mobile radio unit is tuned to as well as the position of the mobile radio unit (as stated above, position may also be determined by the location at which the wireless network receives signals from the wireless transceiver). Therefore, an accurate and complete record of the listening habits of a subscriber may be recorded and provided to broadcasters and vendors to determine accurate ratings. Unlike those ratings techniques provided by companies such as Arbitron, the exact listening patterns of a subscriber are recorded rather than an estimation, in addition to the locations of the subscribers. Such an arrangement can indicate valuable subscriber listening information such as high or low populated events for particular broadcasters (i.e, 35 percent of the audience changed the channel from a certain broadcaster when a commercial began, a program segment pertaining to traffic conditions received a 40 percent higher rating when coupled with a sports report, etc.) as well as the position of large numbers of subscribers. Furthermore, the mobile unit may come equipped with memory so that it may store information pertaining to the received program segments (and in some embodiments, the location of the mobile unit) and either periodically transmit such information (such as once a day or when the mobile unit is deactivated) or allow for the stored information to be transferred wirelessly or through a wired connection to a computing device such as a computer, a PDA, or a mobile phone.

Also, the mobile unit may be configured to perform additional functions as well, including providing May Day functionality and auto-tracking functionality. Insofar as May Day functionality is concerned, the mobile unit may be configured to transmit distress signals to the network operation center in circumstances wherein the vehicle is disabled or wherein the subscriber is otherwise in need of aid. Insofar as auto-tracking functionality is concerned, the mobile unit may provide the ability to track the location of the vehicle or to remotely disable the vehicle, as may be required in the event the vehicle is stolen.

In its various implementations, fees may be charged by operators of the interactive radio network to individual subscribers of the network for access to the network. Additionally, fees may be charged to broadcasters, advertisers, or the like for access to the system.

The invention has been described with reference to specific exemplary systems of an interactive radio system. Principles of the invention, however, are applicable to either applications and to achieve other ends. Hence, the exemplary embodiments described herein should not be construed as limiting the scope of the invention.

1. A system for use with a mobile unit having a broadcast receiver for receiving broadcast transmissions from broadcasters and a transmitter for transmitting wireless signals to the system, said system comprising:
means for receiving a broadcast attribute signal transmitted from the mobile unit, said broadcast attribute signal identifying at least one attribute of a broadcast transmission received by the mobile unit from a broadcaster; and
means, responsive to receipt of said broadcast attribute signal, for providing information to the user of the mobile unit via the Internet, said information representative of the content of the broadcast transmission received by the mobile unit.

2. The system of claim 1 wherein the broadcasts are radio broadcasts and wherein the broadcast receiver of the mobile unit includes a broadcast radio receiver.

3. The system of claim 1 wherein the wireless transmitter of the mobile unit is a satellite wireless communication device, cellular telephone or other local wireless system transmitter.

4. The system of claim 1 wherein said broadcast attribute signal identifies the carrier frequency of the broadcast and the date and time of day of the broadcast; and
wherein said means for providing information via the Internet site representative of content of the broadcast transmission includes
means for identifying the broadcaster based at least in part upon the carrier frequency of the broadcast; and
means for determining the content of the broadcast transmission based on the identity of the broadcaster and the date and time of the broadcast.

5. The system of claim 4
wherein said broadcast attribute signal also includes information identifying the geographical location of the mobile unit; and
wherein said means for identifying the broadcaster includes
means for inputting the carrier frequencies of various broadcasts;
means for inputting the geographical locations of various broadcasters;
means for identifying the broadcaster based upon the carrier frequency of the broadcast transmission, the geographical location of the broadcaster, and the geographical location of the mobile unit.

6. The system of claim 4
wherein all broadcasts processed by the system are broadcast by broadcasters in a single general geographical location; and
wherein said means for identifying the broadcaster includes
means for inputting the carrier frequencies of various broadcasts;
means for identifying the broadcaster based upon the carrier frequency of the broadcast transmission.

7. The system of claim 1
wherein said broadcast attribute signal includes information identifying the content of the broadcast transmission; and
wherein said means for providing information via the Internet representative of the content of the broadcast transmission extracts the information from the broadcast attribute signal.

8. The system of claim 1
wherein said broadcast attribute signal includes information representative of the broadcaster and the date and time of the broadcast; and
wherein said means for providing information via the Internet representative of content of the broadcast transmission includes means for determining the content of the broadcast transmission received by the mobile unit based at least in part upon the information of the broadcast attribute signal.

9. The system of claim 8 wherein said means for determining the content of the broadcast transmission includes
means for inputting a list of radio program segments broadcast by the broadcaster including the date and time of broadcast of the segments; and
means for identifying the program segment broadcast by the broadcaster based upon the date and time identified by the broadcast attribute signal.

10. The system of claim 1 wherein said broadcast transmission is a frequency modulated (FM) signal or an amplitude modulated (AM) signal.

11. The system of claim 1 further including means for receiving a client identifier signal transmitted from the mobile unit, said client identifier signal identifying at least one attribute of a user of the mobile unit.

12. The system of claim 1 wherein said means for providing information via the Internet transmits the information via an email message to an ISP address associated with the user identified by the client identifier signal.

13. The system of claim 1 wherein said means for providing information via the Internet provides the information in an Internet web site accessible by the user.

14. The system of claim 1 wherein said means for providing information representative of said content of the broadcast transmission also provides an identification of the broadcaster and the date and time of the broadcast.

15. The system of claim 1 wherein said means for providing information representative of said content of the broadcast transmission provides an identification of a program segment of the broadcast.

16. The system of claim 15 wherein the program segment is an advertisement provided by an advertiser and wherein said identification of the content of the program segment includes an identification of goods or services provided by the advertiser.

17. The system of claim 16 wherein said identification of the content of the program segment includes an identification of an Internet site associated with the advertiser.

18. The system of claim 15 wherein the program segment is a musical selection performed by a performer and wherein said identification of the content of the program segment includes the name of the musical selection and of the performer.

19. The system of claim 18 wherein said identification of the content of the program segment includes a link to an Internet site associated with the performer.

20. The system of claim 18 wherein said identification of the content of the program segment includes information pertaining to purchasing the musical selection.

21. The system of claim 20 further including means for receiving a purchase order for the musical selection and means for fulfilling the purchase order.

22. The system of claim 21 wherein said means for fulfilling the purchase order includes means for generating a digital music file containing music specified by the purchase order and means for transmitting the digital music file containing the music via the Internet to the subscriber.

23. The system of claim 21 wherein said means for fulfilling the purchase order includes means for generating a customized compact disk (CD) containing music specified by the purchase order.

24. A system for use with a mobile unit having a broadcast receiver for receiving broadcast transmissions from broadcasters and a transmitter for transmitting wireless signals to the system, said system comprising:
a receiver for receiving a broadcast attribute signal transmitted from the mobile unit, said broadcast attribute signal identifying at least one attribute of a broadcast transmission received by the mobile unit from a broadcaster; and
a processor, responsive to receipt of said broadcast attribute signal, for providing information to the user of the mobile unit via the Internet, said information representative of the content of the broadcast transmission received by the mobile unit.

25. A method for use with a mobile unit having a broadcast receiver for receiving broadcast transmissions from broadcasters and a transmitter for transmitting wireless signals to the system, said method comprising the steps of:
receiving a broadcast attribute signal transmitted from the mobile unit, said broadcast attribute signal identifying at least one attribute of a broadcast transmission received by the mobile unit from a broadcaster; and
in response to receipt of the broadcast attribute signal, providing information to the user of the mobile unit via the Internet, said information representative of the content of the broadcast transmission received by the mobile unit.

26. A system for use with one or more broadcasters, said system comprising:
a plurality of mobile units each having a broadcast receiver for receiving broadcast transmissions from broadcasters and a transmitter for transmitting signals identifying a selected program segment of the broadcast transmission; and
a network processor having
means for receiving the signals identifying the selected program segment, said signals including a broadcast attribute signal identifying at least one attribute of a program segment received by the mobile unit from one of the broadcasters; and
means, responsive to receipt of said broadcast attribute signal, for providing information to the user of the mobile unit via the Internet, said information representative of the content of the broadcast transmission received by the mobile unit.

27. The system of claim 26 wherein at least one of said mobile units includes means for determining a geographical location of the mobile unit;
means for determining the carrier frequency of the broadcast;
means for determining the date and time of the program segment;
means for storing a subscriber identifier value; and
wherein said receiver transmits the geographical location, the carrier frequency, the date and time and the subscriber identification value to the network processor.

28. The system of claim 27 wherein said means for determining a geographical location of the mobile unit is a global positioning system (“GPS”) device.

29. The system of claim 26 wherein said means for receiving the signals identifying the selected program segment is a cellular network adaptable to determine the location of the mobile unit when transmitting signals.

30. The system of claim 26 wherein said broadcast receiver includes one or more of an analog terrestrial broadcast receiver, a digital terrestrial broadcast receiver, and a digital satellite broadcast receiver.

31. An interactive radio mobile unit for use with an interactive radio system having a receiver for receiving signals pertaining to selected program segments and having a processor for providing information to a user associated with the mobile unit via the Internet with the information being representative of the content of the program segments received by the mobile unit, said mobile unit comprising:
means for receiving broadcast transmissions from broadcasters;
means for determining a geographical location of the mobile unit;
means for determining the carrier frequency of the broadcast;
means for determining the date and time of the program segment;
means for storing a user identifier value; and
means for transmitting the geographical location, the carrier frequency, the date and time, and the user identifier value to the network processor.

32. A method for use with an interactive radio system comprising the steps of:
receiving signals from an mobile unit representative of one or more radio broadcasts received by the mobile unit and selected by a user of the mobile unit;
determining the identities of musical selections corresponding to the radio broadcasts selected by the user;
generating a customized music file containing a plurality of the musical selections selected by the user; and
providing the customized digital music file to the user.

33. The method of claim 32 wherein the step of providing the customized music file includes the steps of generating a customized compact disk (CD) containing the digital music file and delivering the CD to the user.

34. The method of claim 32 wherein the step of providing the customized music file includes the steps of transmitting the customized digital music file to the user via the Internet.

35. An interactive media system comprising:
a broadcaster broadcasting program segments;
a mobile unit for receiving the program segments and for transmitting subscriber command signals containing data to identify one or more program segments;
a communications network for receiving the transmitted subscriber command signals;
a subscriber access device with a user interface for displaying information; and
a network operations center coupled to said communications network for associating said transmitted subscriber command signals with specific broadcasted program segments, wherein said network operations center is further coupled to said subscriber access device for sending content signals with information associated to said broadcasted program segments to be displayed on said subscriber access device.

36. The interactive media system of claim 35 further comprising means for determining the position of said mobile unit and means for providing information associated with said broadcasted program segment based on the position of said mobile unit.

37. An interactive media system comprising:
a broadcaster broadcasting program segments;
a mobile unit for receiving the program segments and for transmitting subscriber command signals containing data identifying the program segment via a wireless data communications device with a user interface for displaying information;
a communications network for receiving and transmitting wireless data signals; and
a network operations center coupled to said communications network for receiving through said communications network transmitted subscriber command signals from said mobile unit and associating said transmitted subscriber command signals with specific broadcasted program segments, and transmitting back to the wireless data communications device content data signals containing information pertaining to the specific broadcasted program segments to be displayed on the user interface of the wireless data communications device.

38. An interactive media system comprising:
a broadcasting station broadcasting program segments with embedded program information;
a mobile unit receiving broadcast transmissions from said broadcasting station and a transmitter for transmitting subscriber command signals containing data incorporating information identifying the embedded program information;
a communications network for receiving the transmitted subscriber command signals from said mobile unit;
a network operations center coupled to said communications network for extracting program segment identification from the subscriber command signals and associating said identification with information pertaining to the program segment;
a subscriber access device coupled to said network operations center for displaying information pertaining to the program segment.

39. An interactive media system for coupling a subscriber to an advertiser comprising:
a broadcasting station broadcasting transmissions;
a mobile unit receiving broadcast transmissions from said broadcasting stations and a transmitter for transmitting subscriber command signals associated with the broadcast transmissions;
a receiving unit for receiving the transmitted subscriber command signals;
a processing unit coupled to said receiving unit for associating the subscriber command signals with at least one advertiser telephone number;
a communication unit coupled to said processing unit for initiating a telephonic connection between the subscriber and the advertiser via the telephone number.

40. The interactive media system of claim 39, wherein said processing unit further associates the geographical position of said mobile unit with the at least one advertising telephone number.

41. The interactive media system of claim 39, wherein said processing unit further associates a user profile specific to the user with the at least one advertising telephone number.

42. An interactive media system for coupling a subscriber to an advertiser comprising:
a broadcasting station broadcasting program segments and embedded telephone numbers associated with the program segments;
a mobile unit receiving program segments and the associated telephone numbers from said broadcasting stations; and
a communication unit coupled to said mobile unit for initiating a telephonic connection between the subscriber and an advertiser via the telephone number associated with a program segment.

43. An interactive media system comprising:
a broadcaster broadcasting program segments;
a mobile unit containing:
a receiver for receiving the program segments;
a transceiver for transmitting subscriber command signals containing data that can be extracted to identify program segments and for receiving content data signals associated with said program segments; and
a display for displaying information received via said transceiver associated with said content data signals;
a wireless communications network for receiving subscriber command signals and transmitting content data signals; and
a network operations center coupled to said wireless communications network for receiving through said wireless communications network transmitted subscriber command signals from said mobile unit and associating said transmitted subscriber command signals with specific broadcasted program segments, and transmitting back to the mobile unit through said wireless communications network content data signals containing information pertaining to the specific broadcasted program segments.

44. An interactive media system comprising:
a plurality of broadcasters broadcasting program segments;
a wireless communications network for transmitting information pertaining to said broadcasters; and
at least one mobile unit containing:
a broadcast radio receiver for receiving program segments from local broadcasters;
a communications receiver for receiving data associated with a plurality of local broadcasters from said wireless communications network;
a display for displaying the data received via said communications receiver; and
a selection device for tuning the broadcast radio receiver to a local broadcaster displayed on said display.

45. The interactive media system of claim 44, further comprising a network operations center coupled to said wireless communications network for generating information pertaining to said broadcasters within the receiving range of said broadcast radio receiver in said mobile unit.

46. The interactive media system of claim 45, wherein said mobile unit further comprises a GPS unit, and a transmitter for transmitting to said network operations center information pertaining to the location of said mobile unit.

47. The interactive media system of claim 45, wherein said mobile unit further comprises a transmitter for transmitting signals, wherein said transmitted signals are detectable by said communications network and used to determine the location of said mobile unit.

48. The interactive media system of claim 47, wherein said communications network determines the location of said mobile unit by triangulation of the transmitted signals.

49. The interactive media system of claim 45, wherein said information pertaining to said broadcasters transmitted by said wireless communications network includes a list of available broadcasters and information pertaining to the program segments broadcast by each broadcaster.

50. A mobile unit for use with a plurality of broadcasters broadcasting program segments comprising:
a broadcast radio receiver for receiving the program segments from the broadcasters;
a broadcaster identification database containing a list of broadcasters and associated frequency and coverage areas for each broadcaster;
means for determining the location of the mobile unit;
means for extracting a list of local broadcasters within the receiving range of said broadcast radio receiver from the broadcast identification database based on the location of the mobile unit;
a display for displaying the list of local broadcasters; and
a selection unitselectable to to tune to the frequency of said broadcast radio receiver to a local broadcaster displayed on said display.

51. The mobile unit of claim 50 wherein said means for determining the location of said mobile unit is a GPS receiver.

52. The mobile unit of claim 50 wherein said mobile unit further comprises a transceiver for transmitting signals via a communications network, wherein said transmitted signals are detectable by the communications network and used to determine the location of said mobile unit and wherein said communications network may transmit signals to be received by said transceiver pertaining to the location of said mobile unit.

53. The mobile unit of claim 50 wherein said means for determining the location of said mobile unit includes a subscriber input device.

54. An interactive media system with broadcast monitoring comprising:
a broadcaster broadcasting program segments;
a mobile unit for receiving the program segments and for transmitting subscriber command signals containing data identifying the program segment;
a communications network for receiving the transmitted subscriber command signals;
a subscriber access device with a user interface for displaying information;
a monitoring device comprising a receiver for receiving the broadcasted program segments and associating said program segments with a specific program segment; and
a network operations center coupled to said monitor, coupled to said communications network for associating said transmitted subscriber command signals with a specific broadcasted program segment as determined by said monitor, and further coupled to said subscriber access device for sending a content signal with information pertaining to said broadcasted program segment to be displayed on said subscriber access device.

55. An interactive media system for coupling a subscriber to an advertiser comprising: a broadcasting station broadcasting transmissions;
a mobile unit receiving broadcast transmissions from said broadcasting stations and a transmitter for transmitting subscriber command signals associated with the broadcast transmissions;
a receiving unit for receiving the transmitted subscriber command signals;
a processing unit coupled to said receiving unit for associating the subscriber command signals with at least one communication gateway identifier;
a communication channel coupled to said processing unit for initiating an communication gateway between the user and the advertiser via a communication system associated with said communication gateway identifier.

56. A method for tracking the usage of a broadcast system having a broadcaster broadcasting program segments, a mobile unit for receiving the program segments and for transmitting subscriber command signals containing data to identify the program segments, a communications network for receiving the transmitted subscriber command signals, and a network operations center coupled to the communications network for associating the transmitted subscriber command signals with specific broadcasted program segments by a plurality of subscribers comprising the steps of:
providing each of the plurality of subscribers a mobile unit for receiving the program segments and for transmitting subscriber command signals containing data to identify the broadcaster;
transmitting from the mobile unit upon a predetermined condition, a subscriber command signal containing data to identify the broadcaster broadcasting the program segments received by the mobile unit;
receiving the transmitted subscriber command signal at the network operations center via the communications network;
associating the transmitted subscriber command signal with one or more program segments; and
providing data pertaining to the program segments received by the mobile units of a plurality of subscribers.

57. The method of claim 56 wherein the transmitted subscriber command signal received at the network operations center via the communications network contains information pertaining to the location of the mobile unit when receiving a program segment and further comprising the step of providing data pertaining to the location of the mobile unit when receiving program segments for a plurality of subscribers.

58. The method of claim 56 wherein said predetermined condition is a change in the tuned frequency of the mobile unit.

59. The method of claim 56 wherein said predetermined condition is a preset interval.

60. The method of claim 56 wherein a subscriber command signal is sent in response to a command from the network operations center.

61. The method of claim 60 wherein subscriber command signals are stored by the mobile unit and sent upon a command from the network operations center.

62. The method of claim 60 wherein subscriber command signals are stored by the mobile unit and sent upon a command from the subscriber.
